(19) United States
(12) Patent Application Publication
(10) Pub. No.: US 2026/0313667 A1
(43) Pub. Date: Oct. 8, 2026

(54) METHOD PERFORMED BY USER EQUIPMENT, AND USER EQUIPMENT

(71) Applicant: SHARP KABUSHIKI KAISHA, Sakai City, Osaka (JP)

(72) Inventors: Yinan ZHAO, Shanghai (CN); Chao LUO, Shanghai (CN); Renmao LIU, Shanghai (CN)

(21) Appl. No.: 19/482,894

(22) PCT Filed: May 9, 2024
(86) PCT No.: PCT/CN2024/091926

§ 371 Date: Nov. 10, 2025

(30) Foreign Application Priority Data
May 12, 2023 (CN) 202310539899.3

(51) Int. Cl. H04W 72/25; H04L 5/00; H04W 64/00

(52) U.S. Cl. CPC H04W 72/25; H04L 5/0053; H04W 64/00

(57) ABSTRACT

The present invention provides a method performed by a user equipment (UE), characterized by comprising: receiving SCI in a slot (aa) of a dedicated positioning resource pool eⱼ, and determining (bb) SL-PRS resources (cc), (dd), . . . , and (ee) in the resource pool eⱼ, wherein (bb) is an integer greater than or equal to 1 and less than or equal to (ff), wherein (ff) is equal to 2 or 3, and an SL-PRS resource identifier of the SL-PRS resource (cc) is determined by a lowest subchannel of a PSCCH carrying the SCI, and SL-PRS resource identifiers of the SL-PRS resources (dd), . . . , and (ee) are determined by a resource indicator value (RIV) indicated by a field in the SCI.

### TECHNICAL FIELD

The present invention relates to a method performed by a user equipment, and a user equipment.

### BACKGROUND ART

In a wireless communication system, information may be exchanged between different communication nodes. Wireless communication may be performed on a licensed spectrum and/or an unlicensed spectrum. One example of a wireless communication system is a system standardized by the 3rd Generation Partnership Project (3GPP), for example, a 4G system based on Long-Term Evolution (LTE) radio access technology or an evolved system thereof, or a 5G system based on New Radio (NR) radio access technology or an evolved system thereof. In a communication system based on 3GPP specifications, examples of the communication nodes may include a user equipment (UE) and a base station (e.g., an eNB or a gNB). A radio link from a base station to a UE may be referred to as a downlink (DL). A radio link from a UE to a base station may be referred to as an uplink (UL). A radio link between UEs may be referred to as a sidelink (SL). An interface for wireless transmission and/or reception between a base station and a UE may be referred to as a Uu interface (e.g., an NR-Uu interface based on NR, or an LTE-Uu interface based on LTE). An interface for wireless transmission and/or reception between UEs may be referred to as a PC5 interface (e.g., an NR-PC5 interface based on NR, or an LTE-PC5 interface based on LTE).

One or more positioning and/or ranging techniques may be supported in a wireless communication system. When a UE is positioned and/or ranged, information such as a location (e.g., absolute location; or relative location) and/or direction of the UE may be calculated or estimated according to measurement of a downlink signal, and/or measurement of an uplink signal, and/or measurement of a sidelink signal. In order to support communication on a licensed spectrum and/or an unlicensed spectrum, and/or UE positioning on a licensed spectrum and/or an unlicensed spectrum, a series of problems need to be solved, e.g., channel access mechanisms, physical layer channel and/or signal structures, physical layer control information and/or signaling procedures (e.g., a synchronization procedure and a feedback and/or determination mechanism), control information and/or signaling procedures of a higher layer, resource allocation and/or management, and coexistence among different systems.

### PRIOR ART DOCUMENTS

### Non-Patent Documents

Non-Patent Document 1: RP-170379, Revision of SI: Study on New Radio Access Technology, 3GPP TSG RAN Meeting #75
Non-Patent Document 2: RP-191971, Revised WID: New Radio Access Technology, 3GPP TSG RAN Meeting #85
Non-Patent Document 3: RP-190224, Revised SID: Study on NR V2X, 3GPP TSG RAN Meeting #83
Non-Patent Document 4: RP-200129, Revised WID on 5G V2X with NR sidelink, 3GPP TSG RAN Meeting #87-e
Non-Patent Document 5: RP-202846, Revised WID on NR Sidelink enhancement, 3GPP TSG RAN Meeting #90-e
Non-Patent Document 6: RP-222806, Revised WID: NR sidelink evolution, 3GPP TSG RAN Meeting #98-e
Non-Patent Document 7: RP-182155, Revised SID: Study on NR positioning support, 3GPP TSG RAN Meeting #81
Non-Patent Document 8: RP-200218, Revised WID: NR positioning support, 3GPP TSG RAN Meeting #87-e
Non-Patent Document 9: RP-210903, Revised WID: NR Positioning Enhancements, 3GPP TSG RAN Meeting #91-e
Non-Patent Document 10: RP-222616, Revised SID on Study on expanded and improved NR positioning, 3GPP TSG RAN Meeting #97-e
Non-Patent Document 11: RP-223549, New WID on Expanded and Improved NR Positioning, 3GPP TSG RAN Meeting #98-e

### SUMMARY OF THE INVENTION

In order to address at least part of the aforementioned issues, the present invention provides a method performed by user equipment, and user equipment, which use one or more parameters (e.g., an SL-PRS resource identifier; or an RE offset) of an SL-PRS resource associated with SCI to determine the same parameter of other SL-PRS resources indicated by the SCI, greatly improving the efficiency of signaling and simplifying the design of the SCI.

According to the present invention, a method performed by a user equipment is provided. The method is characterized by comprising: receiving SCI in a slot

$${t}_{{i}_{0}}^{e , j}$$

of a dedicated positioning resource pool eⱼ, and determining

$${N}_{RSP}^{e , j , SCI , {k}_{0}}$$

SL-PKS resources

$${r}_{0}^{e , j , SCI , {k}_{0}} , {r}_{1}^{e , j , SCI , {k}_{0}} , … , and {r}_{{N}_{RSP}^{e , j , SCI , {k}_{0}} - 1}^{e , j , SCI , {k}_{0}}$$

in the resource pool eⱼ, wherein a slot in which

$${r}_{0}^{e , j , SCI , {k}_{0}}$$

is located is the slot

$${t}_{{i}_{0}}^{e , j} ,$$

and slots in which

$${r}_{1}^{e , j , SCI , {k}_{0}} , … , and {r}_{{N}_{RSP}^{e , j , SCI , {k}_{0}} - 1}^{e , j , SCI , {k}_{0}}$$

are respectively located and

$${N}_{RSP}^{e , j , SCI , {k}_{0}}$$

are indicated by a time resource indicator value in the SCI, and a common SL-PRS resource identifier of

$${r}_{0}^{e , j , SCI , {k}_{0}} , {r}_{1}^{e , j , SCI , {k}_{0}} , … , and {r}_{{N}_{RSP}^{e , j , SCI , {k}_{0}} - 1}^{e , j , SCI , {k}_{0}}$$

is determined by a lowest RB of a PSCCH carrying the SCI.

Furthermore, according to the present invention, a user equipment is provided, comprising: a processor; and a memory storing instructions, wherein the instructions, when run by the processor, perform the above method.

Therefore, the present invention provides a method, which uses one or more parameters (e.g., an SL-PRS resource identifier; or an RE offset) of an SL-PRS resource associated with SCI to determine the same parameter of other SL-PRS resources indicated by the SCI, greatly improving the efficiency of signaling and simplifying the design of the SCI.

### BRIEF DESCRIPTION OF THE DRAWINGS

The above and other features of the present invention will be more apparent from the following detailed description in combination with the accompanying drawings, in which:

FIG. 1 shows a flowchart corresponding to a method performed by a user equipment according to Embodiment 1 of the present invention.

FIG. 2 shows a flowchart corresponding to a method performed by a user equipment according to Embodiment 2 of the present invention.

FIG. 3 shows a block diagram of a user equipment according to the present invention.

### DETAILED DESCRIPTION OF PREFERRED EMBODIMENTS

The following describes the present invention in detail with reference to the accompanying drawings and specific implementations. It should be noted that the present invention should not be limited to the specific implementations described below. In addition, detailed descriptions of well-known technologies not directly related to the present invention are omitted for the sake of brevity, in order to prevent obscuring the understanding of the present invention.

A plurality of embodiments according to the present invention will be specifically described below using 5G (also referred to as NR or 5G NR) wireless communication system specifications formulated by the 3GPP and subsequent evolved versions thereof (e.g., 5G Advanced) as an exemplary application environment. However, it shall be noted that the present invention is not limited to the following embodiments, but rather is applicable to many other wireless communication systems, such as wireless communication systems later than 5G, or 4G mobile communication systems earlier than 5G, e.g., Long Term Evolution (LTE), LTE-Advanced, LTE-Advanced Pro, etc.

The terms given in the present invention may be named differently in different wireless communication systems, but unified terms are used in the present invention. When applied to a specific system, the terms may be replaced with terms used in the corresponding system.

Unless otherwise specified, in all embodiments and implementations of the present invention:
“Node” and “communication node” are interchangeable.
The “node” may refer to a UE, or a network node (e.g., a base station), or a communication node in another form.
“Base station” may refer to a 4G base station, e.g., an eNB (E-UTRAN Node B, where E-UTRAN stands for Evolved Universal Terrestrial Radio Access Network); or a 5G base station, e.g., a gNB (a node that provides NR user plane and control plane protocol terminations to a UE and is connected to a 5G core network via an NG interface), or an ng-eNB (a node that provides E-UTRA user plane and control plane protocol terminations to a UE and is connected to a 5G core network via an NG interface, wherein E-UTRA stands for Evolved Universal Terrestrial Radio Access); or a base station in another form.
“Lower layer(s)” may refer to one or more protocol layers or protocol sub-layers below a reference protocol layer or a reference protocol sub-layer in a specific protocol stack. For example, if the reference protocol layer or the reference protocol sub-layer is an RRC layer, then “lower layer” may refer to a MAC layer, and/or a physical layer; as another example, if the reference protocol layer or the reference protocol sub-layer is a MAC layer, then “lower layer” may refer to a physical layer. Unless otherwise specified, the reference protocol layer or the reference protocol sub-layer is a MAC layer. A “lower layer” may also be referred to as a “low layer” if this causes no ambiguity.
“Higher layer(s)” or “upper layer(s)” may refer to one or more protocol layers or protocol sub-layers above a reference protocol layer or a reference protocol sub-layer in a particular protocol stack (e.g., an access stratum protocol stack). For example, if the reference protocol layer or the reference protocol sub-layer is a physical layer (also referred to as “Layer 1”), “higher layer” may refer to a Medium Access Control (MAC) layer, and/or a Radio Link Control (RLC) layer, and/or a Packet Data Convergence Protocol (PDCP) layer, and/or a PC5-RRC (Radio Resource Control) layer, and/or a PC5-S layer, and/or an RRC layer, and/or another protocol layer or protocol sub-layer. Unless otherwise specified, the reference protocol layer or the reference protocol sub-layer is a physical layer. A “higher layer” may also be referred to as a “high layer” if this causes no ambiguity.
“Signaling” may refer to signaling of a physical layer, or signaling of a higher layer.
“Configure” may mean that in a communication node (e.g., a UE), a protocol layer (e.g., an RRC layer) entity provides configuration information to another protocol layer (e.g., physical layer) entity.
“Configuration” may mean that a protocol layer (e.g., RRC layer) entity of a communication node (e.g., a base station) provides configuration information to a peer protocol layer entity of another communication node (e.g., a UE) (e.g., transmission, from the base station to the UE, of RRC signaling in which the configuration information is included, or transmission, from a UE-A to a UE-B, of PC5-RRC signaling in which the configuration information is included).
“Pre-configure” may mean that corresponding configuration information is preset in a specific storage location in a communication node (e.g., a UE), or corresponding configuration information is preset in a specific storage location accessible by a UE.
“Configure” may be replaced by “(pre) configure” (meaning “configure or preconfigure”).
“Number” may refer to “total number”. For example, “the number of subchannels in a resource pool” may refer to the total number of subchannels in the resource pool.
Sequence “t₀, t₁, . . . , t_{N-1}” may be used to represent a case where N is greater than or equal to 1. For example, if N=1; accordingly, the sequence is “t₀”. For another example, if N=2; accordingly, the sequence is “t₀, t₁”.
Elements in a time sequence (e.g., denoted as t₀, t₁, . . . , t_{N-1}) or a corresponding set (e.g., denoted as {t₀, t₁, . . . , t_{N-1}}) may appear in chronological order, for example, a time corresponding to t₀ is earlier than (or no later than) a time corresponding to t₁, the time corresponding to t₁ is earlier than (or no later than) a time corresponding to t₂, and so on.
μ may represent a subcarrier spacing configuration, for example, μ=0. Δf may represent a corresponding subcarrier spacing (SCS), for example, μ=0 corresponds to Δf=15 kHz.
A “symbol” may refer to an Orthogonal Frequency Division Multiplexing (OFDM) symbol.
A resource may correspond to one or a plurality of the following:
   One or more parameters in a time-domain. For example, a starting symbol of the resource, a starting slot of the resource, the number of symbols occupied by the resource, or the number of slots occupied by the resource.
   One or more parameters in a frequency-domain. For example, a starting sub-channel of the resource, a starting resource block (RB) of the resource, a starting subcarrier of the resource, the number of sub-channels occupied by the resource, the number of RBs occupied by the resource, or the number of subcarriers occupied by the resource.
   One or more parameters in a code-domain. For example, a cyclic shift value corresponding to the resource or a corresponding cyclic shift index, or a cyclic shift pair value corresponding to the resource or a corresponding cyclic shift pair index.
   One or more parameters in a spatial-domain. For example, a layer corresponding to the resource, wherein a “layer” may refer to a Multiple Input Multiple Output (MIMO) layer.
A “layer” may refer to one of one or more layers to which a Transport Block (TB) is mapped in spatial multiplexing. The mapping may also be considered as a mapping of a codeword corresponding to the TB to the one or more layers.
An “RB” may refer to a physical resource block (PRB), a virtual resource block (VRB), a common resource block (CRB), or an interlaced resource block (IRB). Accordingly, an “RB index” may refer to a PRB index, or a VRB index, or a CRB index, or an IRB index.
“Number” and “index” are interchangeable. For example, the number of an RB may also be referred to as the index of the RB. As another example, “numbering an RB as 0” may also be expressed as “indexing an RB as 0”.
The indexes of elements in a sequence (or an array, or a list, or a set, or the like) may start from 0. For example, the first RB of an RB set may be referred to as RB 0 of the RB set.
Bits in a bitmap (or referred to as a “bit string”) consisting of

$${N}_{BM}^{ref}$$

bits may be sequentially indexed as 0, 1, . . . , and

$${N}_{BM}^{ref} - 1$$

in an order from a most significant bit (MSB) to a least significant bit (LSB) (or in an order from the LSB to the MSB), where

$${N}_{BM}^{ref}$$

may be referred to as a size (or “length”) of the bitmap, and the MSB may be the leftmost bit of the bitmap, or the rightmost bit of the bitmap.
An object (e.g., a subcarrier, a slot, or a cyclic shift) may be represented by an index thereof, where the index may be an index within a set. Accordingly, the index may be referred to as an “identifier” (ID) of the object. For example, each element in a subchannel set

$${SC}_{ref} = \{ {sc}_{0}^{ref} , {sc}_{1}^{ref} , {sc}_{2}^{ref} , {sc}_{3}^{ref} , {sc}_{4}^{ref} \}$$

may represent one subchannel, and/or a subchannel index corresponding to the subchannel.
In signaling, an object may be indicated by using an index of the object.
If a corresponding number is not specified when an object is mentioned, the number of the object may be one or multiple. For example, in the expression “performing transmission(s) on a channel”, the “transmission(s)” may correspond to one transmission, or a plurality of transmissions.
Δ(x₁, x₂) may represent an offset between x₁ and x₂, where x₁ and x₂ may be two parameters (or variables) that can be compared, or two possible values of one parameter (or variable). For example, if x₁ and x₂ represent two slots in a resource pool, then Δ(x₁, x₂) may be defined as a difference between a physical slot index corresponding to the slot x₂ and a physical slot index corresponding to the slot x₁, or as a difference between a logical slot index corresponding to the slot x₂ and a logical slot index corresponding to the slot x₁.
An “offset between x₁ and x₂” may also be referred to as an offset of x₂ with respect to x₁ or an offset of x₂ relative to x₁.
An “offset between x₁ and x₂” may also be referred to as an offset from x₁ to x₂.
If Δ(x₁, x₂)=D, x₂ may be denoted as x₂=ADD(x₁, D).
If Δ(x₁, x₂)=D, x₁ may be denoted as x₁=SUBTRACT (x₂, D).
An offset between two subcarriers may be an offset between center frequencies of the two subcarriers.
A modulo operation may be defined as r≡a mod N, where
   r is a remainder;
   a=N×q+r, where q=└a/N┘. q may be referred to as an integer quotient of a and N.
   0≤r<|N|.
A round operation may be denoted as b=round (a), where b may be defined as an integer closest to a. If there are two integers closest to a, b may be defined as the larger of the two integers, or as the smaller of the two integers.
Sidelink control information (SCI) may refer to 1^{st}-stage SCI and/or 2^{nd}-stage SCI.
An SL may be an NR SL.
“Sidelink” may refer to NR sidelink.
A “carrier” may refer to a sidelink carrier.
A “bandwidth part” may refer to a sidelink bandwidth part.
A “resource pool” may refer to a sidelink resource pool.
A “sidelink slot” may refer to a slot configured with a sidelink resource (e.g., a slot in a resource pool). The “sidelink resource” may or may not include a resource for a specific purpose. The “resource for a specific purpose” may be a resource for a synchronization procedure, for example, a resource for transmitting an S-SS/Physical Sidelink Broadcast Channel or Sidelink-Synchronization Signal/Physical Sidelink Broadcast Channel (S-SS/PSBCH) block.
A “physical slot” may refer to a slot belonging to a certain physical slot set, where the physical slot set may be all slots in a continuous period of time (e.g., a frame period having duration of 1024 frames). Physical slots in the physical slot set may be sequentially indexed as 0, 1, . . . in chronological order.
A “logical slot” may refer to a slot belonging to a slot set of a certain resource pool, wherein the slot set may be all slots belonging to the resource pool in a continuous period of time (e.g., a frame period having duration of 1024 frames). Logical slots in the slot set may be sequentially indexed as 0, 1, . . . in chronological order.
A “logical slot” may refer to a slot that may be configured to belong to a slot set of a certain resource pool.
A “sidelink slot” may refer to a slot that belongs to a slot set of a certain resource pool.
A “sidelink slot” may refer to a slot that may be configured to belong to a slot set of a certain resource pool.
A sidelink transmission which multiplexes a physical sidelink shared channel (PSSCH) and a physical sidelink control channel (PSCCH) associated therewith in the same resource (e.g., a number of consecutive symbols in a sidelink slot in a time domain, and a number of consecutive subchannels in a frequency domain) may be referred to as a “PSCCH/PSSCH transmission” (or a PSSCH/PSCCH transmission).
In a time-domain, a “frame” (or referred to as a “radio frame”) may be a system frame or a direct frame. A frame number period (e.g., denoted as T_{FNP}) may correspond to a predefined or preconfigured parameter, or may be determined according to one or more predefined or preconfigured parameters, e.g., T_{FNP}=1024 frames. The duration of each frame may be T_{f}=10 milliseconds, which may include 10 subframes, wherein the duration of each subframe is T_{sf}=1 millisecond. Each subframe may include

$${N}_{slot}^{subframe , μ}$$

slots, e.g.,

$${N}_{slot}^{subframe , μ} = {2}^{μ}$$

An index of a slot in a subframe may be denoted as

$${n}_{s}^{μ} ( {n}_{s}^{μ} ∈ \{ 0 , 1 , … , {N}_{slot}^{subframe , μ} - 1 \} ) .$$

An index of a slot in a frame may be denoted as

$${n}_{s , f}^{μ} ( {n}_{s , f}^{μ} ∈ \{ 0 , 1 , … , {N}_{slot}^{frame , μ} - 1 \} ) ,$$

where

$${N}_{slot}^{frame , μ}$$

may be equal to 10·2^{μ}. A slot index in a frame number period may be denoted as

$${n}_{s , f , p}^{μ} ( {n}_{s , f , p}^{μ} ∈ \{ 0 , 1 , … , {N}_{slot}^{FNP , μ} - 1 \} ) ,$$

where

$${N}_{slot}^{FNP , μ}$$

may be equal to

$${T}_{FNP} \cdot {N}_{slot}^{frame , μ} ( e . g . , 1024 \cdot ( 10 \cdot {2}^{μ} ) ) .$$

“Sidelink grant” may refer to “sidelink dynamic grant” or “sidelink configured grant”.
“Sidelink dynamic grant” and “dynamic sidelink grant” are interchangeable.
“Sidelink configured grant” and “configured sidelink grant” are interchangeable.
“Type 1 sidelink configured grant” and “sidelink configured grant type 1” are interchangeable.
“Type 2 sidelink configured grant” and “sidelink configured grant type 2” are interchangeable.
A sidelink ID (sidelink identity, SL ID) may be a layer 1 sidelink ID or a layer 2 sidelink ID.
A priority (or priority level) may correspond to a priority value. For example, one priority corresponds to a priority value of 0, and another priority corresponds to a priority value of 1.
A priority may each correspond to a priority value in one or more protocol layers (or protocol sublayers), where corresponding priority values in different protocol layers (or protocol sublayers) may be equal or unequal. For example, a priority may correspond to a priority value of 0 at a physical layer, and a priority value of 1 at a higher layer. As another example, another priority may correspond to a priority value of 1 at a physical layer, and a priority value of 2 at a higher layer.
A relationship between the priority order and the corresponding priority value may be: as the priority value increases, the priority (or referred to as “priority order”) decreases. For example, if priority values corresponding to priorities associated with a first sidelink transmission and a second sidelink transmission are 0 and 1, respectively, then the priority of the first sidelink transmission is higher than the priority of the second sidelink transmission.
The relationship between the priority order and the corresponding priority value may be: as the priority value increases, the priority (or referred to as “priority order”) increases. For example, if priority values corresponding to priorities associated with a first sidelink transmission and a second sidelink transmission are 0 and 1, respectively, then the priority of the first sidelink transmission is lower than the priority of the second sidelink transmission.
“Positioning” may refer to “sidelink positioning” or “sidelink ranging”, or to positioning and/or ranging performed by using a technology including sidelink positioning and/or ranging. For example, a “positioning resource pool” may refer to a sidelink positioning resource pool.
A “target UE” may refer to a UE which is being positioned and/or ranged (or referred to as a “device which is being positioned and/or ranged”).
An “anchor UE” may refer to a UE which provides support for positioning and/or ranging of a target UE (or referred to as a “device which provides support for positioning and/or ranging of a target UE”).
A “server UE” (Server UE, or sidelink positioning server UE) may be a UE that provides location calculation for a sidelink positioning and/or ranging-based service. To calculate the location of a target UE, a server UE may interact with other UEs over a PC5 interface. A target UE may be a server UE. One anchor UE may be a server UE.

### Pre-Emb

A positioning-related reference signal transmitted and/or received on a sidelink may be referred to as an SL-PRS (or “SL PRS”, Sidelink Positioning Reference Signal).

On the sidelink, a resource pool may be configured to be used for one or more purposes, including, for example, one or more of sidelink communication, sidelink discovery, and sidelink positioning. A combination of one or more specific purposes may correspond to one “resource pool type”.

Specifically, for example, a resource pool that can be used to transmit and/or receive sidelink channels and/or signals for positioning (e.g., part or all of SL-PRS, sidelink channels and/or signals for carrying positioning-related control information, and sidelink channels and/or signals for carrying positioning-related measurement reports) may be referred to as a “positioning resource pool”. In a positioning resource pool, a frequency-domain resource that can be used for SL-PRS may correspond to part or all of frequency-domain resources in the resource pool (e.g., part or all of RBs in the resource pool; or part or all of subchannels in the resource pool), and a time-domain resource that can be used for SL-PRS may correspond to part or all of time-domain resources in the resource pool (e.g., part or all of symbols in part or all of slots in the resource pool). A positioning resource pool dedicated to positioning may be referred to as a “dedicated positioning resource pool” (or, without risk of confusion, the resource pool may be referred to as a “dedicated resource pool”). A dedicated positioning resource pool may be used to transmit and/or receive only sidelink channels and/or signals for positioning.

For another example, a resource pool that can be used to transmit and/or receive a sidelink channel and/or signal (e.g., a PSCCH, or a PSSCH, or a physical sidelink feedback channel (PSFCH) for sidelink communication may be referred to as a “sidelink communication resource pool”. Optionally, data carried in a PSSCH transmitted in a sidelink communication resource pool (not a positioning resource pool) may include positioning-related information such as control information and/or measurement report defined in a higher-layer protocol. A sidelink communication resource pool dedicated to sidelink communication may be referred to as a “dedicated sidelink communication resource pool”.

For another example, a resource pool that can be used to transmit and/or receive a sidelink channel and/or signal (e.g., a PSCCH, or a PSSCH, or a PSFCH) for sidelink discovery may be referred to as a “sidelink discovery resource pool”. Optionally, data carried in a PSSCH transmitted in a sidelink discovery resource pool (not a positioning resource pool) may include positioning-related information such as control information and/or measurement report defined in a higher-layer protocol. A sidelink discovery resource pool dedicated to sidelink discovery may be referred to as a “dedicated sidelink discovery resource pool”.

A resource pool that can be used for positioning and one or more other purposes (e.g., sidelink communication and/or sidelink discovery) may be referred to as a “shared positioning resource pool” (or, without risk of confusion, the resource pool may be referred to as a “shared resource pool”).

Optionally, in a bandwidth part, a sidelink communication resource pool may always be used for sidelink discovery.

Optionally, in a bandwidth part, if an SL-PRS resource is configured for a sidelink communication resource pool (or, if an “SL-PRS configuration” is associated with the sidelink communication resource pool), the sidelink communication resource pool can be used for positioning, and accordingly, the sidelink communication resource pool is a shared positioning resource pool. One SL-PRS configuration may correspond to one or more resources (e.g., time-domain resources; or frequency-domain resources) for configuring SL-PRS and a parameter related to transmission and/or reception of SL-PRS.

Optionally, one SL-PRS configuration may be associated with one bandwidth part, and the SL-PRS configuration is applied to part or all of resource pools in the bandwidth part, and accordingly, each resource pool associated with the SL-PRS configuration is a shared positioning resource pool.

Optionally, in a bandwidth part, a sidelink communication resource pool may always be used for positioning.

Optionally, in a bandwidth part, if no dedicated sidelink discovery resource pool is configured, any sidelink communication resource pool may be used for sidelink discovery.

Optionally, in a bandwidth part, if no dedicated positioning resource pool is configured, any sidelink communication resource pool may be used for positioning.

Optionally, in a bandwidth part, if no dedicated positioning resource pool is configured, any sidelink discovery resource pool may be used for positioning.

In a dedicated positioning resource pool (e.g., a resource pool eⱼ in a bandwidth part b in a carrier c), a set consisting of all RBs corresponding to frequency-domain resources that can be used for SL-PRS (or all RBs corresponding to all subchannels corresponding to frequency-domain resources that can be used for SL-PRS) may be denoted as

$${RB}_{SP}^{e , j} ,$$

and a set consisting of all subcarriers corresponding to all the RBs in the set

$${RB}_{SP}^{e , j}$$

may be denoted as

$${SC}_{SP}^{e , j}$$

### The set

$${RB}_{SP}^{e , j}$$

may be equal to a set

$${RB}_{j}^{e} ,$$

or may be a subset (e.g., a subset that is predefined or preconfigured or indicated in SCI or other signaling) of the set

$${RB}_{j}^{e} ,$$

where the set

$${RB}_{j}^{e}$$

is a set consisting of all RBs in the resource pool eⱼ (or all RBs corresponding to all subchannels in the resource pool eⱼ). The set

$${SC}_{SP}^{e , j}$$

may is equal to a set

$${SC}_{j}^{e} ,$$

or a subset (e.g., a predefined or preconfigured subset) of the set

$${SC}_{j}^{e} ,$$

where the set

$${SC}_{j}^{e}$$

is a set consisting of all subcarriers corresponding to all RBs in the set

$${RB}_{j}^{e} .$$

A slot (e.g., denoted as

$${t}_{{i}_{0}}^{e , j}$$

in the resource pool eⱼ may include

$${N}_{SPO}^{e , j , t , {i}_{0}} “ SL - PRS$$

occasions” (or referred to as SL-PRS transmission occasions, or SL-PRS transmission resource occasions), for example, denoted as

$${spo}_{0}^{e , j , t , {i}_{0}} , {spo}_{1}^{e , j , t , {i}_{0}} , … , and {spo}_{{N}_{SPO}^{e , j , t , {i}_{0}} - 1}^{e , j , t , {i}_{0}} ,$$

respectively.

$${N}_{SPO}^{e , j , t , {i}_{0}}$$

may be an integer greater than or equal to 1.

$${N}_{SPO}^{e , j , t , {i}_{0}}$$

may correspond to a predefined or preconfigured parameter, or may be determined according to one or more predefined or preconfigured parameters, or may be determined in other ways.

$${N}_{SPO}^{e , j , t , {i}_{0}}$$

may be independent of i₀, for example, for any slot in the resource pool eⱼ,

$${N}_{SPO}^{e , j , t , {i}_{0}} = {N}_{SPO}^{e , j} , where {N}_{SPO}^{e , j}$$

may correspond to a predefined or preconfigured parameter, or may be determined according to one or more predefined or preconfigured parameters, or may be determined in other ways.

For

$$m ∈ \{ 0 , 1 , … , {N}_{SPO}^{e , j , t , {i}_{0}} - 1 \} , {spo}_{m}^{e , j , t , {i}_{0}}$$

may correspond to a symbol set (e.g., denoted as

$${L}_{m}^{e , j , t , {i}_{0}} = \{ {l}_{m , 0}^{e , j , t , {i}_{0}} , {l}_{m , 1}^{e , j , t , {i}_{0}} , … , {l}_{m , {N}_{L , m}^{e , j , t , {i}_{0}} - 1}^{e , j , t , {i}_{0}} \} )$$

in the slot

$${t}_{{i}_{0}}^{e , j}$$

in the time-domain, where

$${N}_{L , m}^{e , j , t , {i}_{0}}$$

may be an integer greater than or equal to 1.

$${N}_{L , m}^{e , j , t , {i}_{0}}$$

may correspond to a predefined or preconfigured parameter, or may be determined according to one or more predefined or preconfigured parameter, or may be determined in other ways.

$${N}_{L , m}^{e , j , t , {i}_{0}}$$

may be independent of part or all of i₀ and m, for example, in any slot in the resource pool eⱼ, for

$$m ∈ \{ 0 , 1 , … {N}_{SPO}^{e , j , t , {i}_{0}} - 1 \} , {N}_{L , m}^{e , j , t , {i}_{0}} = {N}_{L}^{e , j} , {N}_{L}^{e , j}$$

may correspond to a predefined or preconfigured parameter, or may be determined according to one or more predefined or preconfigured parameters, or may be determined in other ways.
Symbols in

$${L}_{m}^{e , j , t , {i}_{0}}$$

may be consecutive symbols, for example, for

$$m ∈ \{ 0 , 1 , … {N}_{L , m}^{e , j , t , {i}_{0}} - 2 \} , {l}_{m , n + 1}^{e , j , t , {i}_{0}} = {l}_{m , n}^{e , j , t , {i}_{0}} + 1.$$

$${l}_{m , 0}^{e , j , t , {i}_{0}}$$

may correspond to a predefined or preconfigured parameter, or may be determined according to one or more predefined or preconfigured parameter, or may be determined in other ways.

$${l}_{m , 0}^{e , j , t , {i}_{0}}$$

may be independent of part or all of i₀ and m, for example, in any slot in the resource pool eⱼ, for

$$m ∈ \{ 0 , 1 , … , {N}_{SPO}^{e , j , t , {i}_{0}} - 1 \} , {l}_{m , 0}^{e , j , t , {i}_{0}} = {l}_{0}^{e , j} , where {l}_{0}^{e , j}$$

may correspond to a predefined or preconfigured parameter, or may be determined according to one or more predefined or preconfigured parameters, or may be determined in other ways.

For

$$m ∈ \{ 0 , 1 , … , {N}_{SPO}^{e , j , t , {i}_{0}} - 1 \} , {spo}_{m}^{e , j , t , {i}_{0}}$$

may multiplex

$${N}_{SPR , m}^{e , j , t , {i}_{0}} “ SL - PRS$$

resources (or referred to as SL-PRS transmission resources, or referred to as SL-PRS transmission occasion resources), for example, denoted as

$${spr}_{m , 0}^{e , j , t , {i}_{0}} , {spr}_{m , 1}^{e , j , t , {i}_{0}} , … , {spr}_{m , {N}_{SPR , m}^{e , j , t , {i}_{0}} - 1}^{e , j , t , {i}_{0}} ,$$

respectively, where

$${N}_{SPR , m}^{e , j , t , {i}_{0}}$$

may be an integer greater than or equal to 1, for example,

$${N}_{SPR , m}^{e , j , t , {i}_{0}} = 1 ; or , {N}_{SPR , m}^{e , j , t , {i}_{0}} = 2 ; or , {N}_{SPR , m}^{e , j , t , {i}_{0}} = 4 ; or , {N}_{SPR , m}^{e , j , t , {i}_{0}} 6 ; or , {N}_{SPR , m}^{e , j , t , {i}_{0}} = 8 ; or , {N}_{SPR , m}^{e , j , t , {i}_{0}} = 12.$$

$${N}_{SPR , m}^{e , j , t , {i}_{0}}$$

may correspond to a predefined or preconfigured parameter, or may be determined according to one or more predefined or preconfigured parameter, or may be determined in other ways.

$${N}_{SPR , m}^{e , j , t , {i}_{0}}$$

may be independent of part or all of i₀ and m, for example, in any slot in the resource pool eⱼ, for

$$m ∈ \{ 0 , 1 , … , {N}_{SPO}^{e , j , t , {i}_{0}} - 1 \} . {N}_{SPR , m}^{e , j , t , {i}_{0}} = {N}_{SPR}^{e , j} , where {N}_{SPR}^{e , j}$$

may correspond to a predefined or preconfigured parameter, or may be determined according to one or more predefined or preconfigured parameters, or may be determined in other ways.

For

$$m ∈ \{ 0 , 1 , … , {N}_{SPO}^{e , j , t , {i}_{0}} - 1 \} , q ∈ \{ 0 , 1 , … , {N}_{SPR , m}^{e , j , t , {i}_{0}} - 1 \} ,$$

an SL-PRS resource

$${spr}_{m , q}^{e , j , t , {i}_{0}}$$

may correspond to the symbol set

$${L}_{m}^{e , j , t , {i}_{0}}$$

in the time domain, and may be mapped to part of all of subcarriers in one or more consecutive RBs in the frequency domain (e.g., the corresponding set is denoted as

$${RB}_{m , q}^{e , j , t , {i}_{0}} ,$$

where a ser consisting of all subcarriers corresponding to all RBs in the set

$${RB}_{m , q}^{e , j , t , {i}_{0}}$$

may be denoted as

$${SC}_{m , q}^{e , j , t , {i}_{0}} ) .$$

$${RB}_{m , q}^{e , j , t , {i}_{0}}$$

may be equal to the set

$${RB}_{SP}^{e , j} ,$$

or a subset of the set

$${RB}_{SP}^{e , j} .$$

$${RB}_{m , q}^{e , j , t , {i}_{0}}$$

may be a predefined or preconfigured set, or may be determined in other ways, for example, a method for determining

$${RB}_{m , q}^{e , j , t , {i}_{0}}$$

may be related to a corresponding sidelink resource allocation mode (or referred to as a sidelink resource allocation scheme).

$${RB}_{m , q}^{e , j , t , {i}_{0}}$$

may be independent of part or all of i₀, m, and q (accordingly,

$${SC}_{m , q}^{e , j , t , {i}_{0}}$$

may be independent of part or all of i₀, m, and q), for example, in any slot in the resource pool eⱼ, for

$$m ∈ \{ 0 , 1 , … , {N}_{SPO}^{e , j , t , {i}_{0}} - 1 \} and q ∈ \{ 0 , 1 , … , {N}_{SPR , m}^{e , j , t , {i}_{0}} - 1 \} , {RB}_{m , q}^{e , j , t , {i}_{0}} = {RB}_{SP , all}^{e , j} , where {RB}_{SP , all}^{e , j}$$

may be a predefined or preconfigured set, or may be determined according to one or more predefined or preconfigured parameters, or may be determined in other ways.
The subcarrier set to which the SL-PRS resource

$${spr}_{m , q}^{e , j , t , {i}_{0}}$$

is mapped may correspond to the same subset of the set

$${SC}_{m , q}^{e , j , t , {i}_{0}}$$

in two different symbols, or respectively correspond to two different subsets of the set

$${SC}_{m , q}^{e , j , t , {i}_{0}} .$$

For a symbol

$${l}_{m , n}^{e , j , t , {i}_{0}} ( n ∈ [ 0 , 1 , … , {N}_{L , m}^{e , j , t , {i}_{0}} - 1 \} ) ,$$

the subcarrier set to which the SL-PRS resource

$${spr}_{m , q}^{e , j , t , {i}_{0}}$$

is mapped may be denoted as

$${SC}_{SP , m , q , n}^{e , j , t , {i}_{0}} .$$

The subcarrier set

$${SC}_{SP , m , q , n}^{e , j , t , {i}_{0}}$$

may correspond to a “comb-like pattern”; accordingly,

$${N}_{SPR , m}^{e , j , t , {i}_{0}}$$

may be referred to as a size of the comb-like pattern (comb size), for example, the subcarrier set

$${SC}_{SP , m , q , n}^{e , j , t , {i}_{0}}$$

may be an intersection of a set

$${SC}_{all}^{e , j , t , {i}_{0}} = \{ x \cdot {N}_{SPR , m}^{e , j , t , {i}_{0}} + ( ( {reo}_{m , q}^{e , j , t , {i}_{0}} + {fro}_{m , q}^{e , j , t , {i}_{0}} ) mod {N}_{SPR , m}^{e , j , t , {i}_{0}} ) \vert x = 0 , 1 , … \}$$

and the set

$${SC}_{m , q}^{e , j , t , {i}_{0}} ,$$

where
a reference point corresponding to x=0 may be subcarrier 0 of CRB 0. Accordingly, each element in the set

$${SC}_{m , q}^{e , j , t , {i}_{0}}$$

may be a subcarrier represented based on the same reference point (e.g., subcarrier 0 of CRB 0).

$${reo}_{m , q}^{e , j , t , {i}_{0}}$$

may be referred to as an RE (resource element) offset of the SL-PRS resource

$${spr}_{m , q}^{e , j , t , {i}_{0}} .$$

$${reo}_{m , q}^{e , j , t , {i}_{0}}$$

may be a value satisfying

$${reo}_{m , q}^{e , j , t , {i}_{0}} ∈ \{ 0 , 1 , … , {N}_{SPR , m}^{e , j , t , {i}_{0}} - 1 \} .$$

$${reo}_{m , q}^{e , j , t , {i}_{0}}$$

may be independent of part or all of i₀ and m. For example, for any slot in the resource pool eⱼ, for

$$m ∈ \{ 0 , 1 , … , {N}_{SPO}^{e , j , t , {i}_{0}} - 1 \} , {reo}_{m , q}^{e , j , t , {i}_{0}} = q .$$

$${reo}_{m , q}^{e , j , t , {i}_{0}}$$

may be used to identify an SL-PRS resource

$${spr}_{m , q}^{e , j , t , {i}_{0}}$$

in a corresponding SL-PRS occasion (i.e.,

$${spo}_{m}^{e , j , t , {i}_{0}}$$

$${fro}_{m , n}^{e , j , t , {i}_{0}}$$

may be indenpendent of part or all of i₀ and m.

$$\{ {fro}_{m , n}^{e , j , t , {i}_{0}} \vert n = 0 , 1 , … \}$$

may be a set related to

$${N}_{SPR , m}^{e , j , t , {i}_{0}} ,$$

for example, if

$${N}_{SPR , m}^{e , j , t , {i}_{0}} = 2 , then {fro}_{m , 0}^{e , j , t , {i}_{0}} = 0 , {fro}_{m , 1}^{e , j , t , {i}_{0}} = 1 ,$$

$${fro}_{m , 2}^{e , j , t , {i}_{0}} = 0 , {fro}_{m , 3}^{e , j , t , {i}_{0}} = 1 , … ;$$

for another example, if

$${N}_{SPR , m}^{e , j , t , {i}_{0}} = 4 ,$$

then

$${fro}_{m , 0}^{e , j , t , {i}_{0}} = 0 , {fro}_{m , 1}^{e , j , t , {i}_{0}} = 2 , {fro}_{m , 2}^{e , j , t , {i}_{0}} = 1 , {fro}_{m , 3}^{e , j , t , {i}_{0}} = 3 , {fro}_{m , 4}^{e , j , t , {i}_{0}} = 0 , {fro}_{m , 5}^{e , j , t , {i}_{0}} = 2 , {fro}_{m , 6}^{e , j , t , {i}_{0}} = 1 , {fro}_{m , 7}^{e , j , t , {i}_{0}} = 3 , …$$

The number of SL-PRS resources in the slot

$${t}_{{i}_{0}}^{e , j}$$

in the resource pool eⱼ may be denoted as

$${N}_{SR}^{e , j , t , {i}_{0}} ,$$

for example,

$${N}_{SR}^{e , j , t , {i}_{0}} = {\sum }_{m = 0}^{{N}_{SPO}^{e , j , t , {i}_{0}} - 1} {N}_{SPR , m}^{e , j , t , {i}_{0}} \cdot {N}_{SR}^{e , j , t , {i}_{0}}$$

may be independent of i₀, for example,

$${N}_{SR}^{e , j , t , {i}_{0}} = {N}_{SPO}^{e , j} \cdot {N}_{SPR}^{e , j} .$$

### Each of the

$${N}_{SR}^{e , j , t , {i}_{0}}$$

SL-PRS resources may correspond to an “SL-PRS resource identifier” (or SL-PRS resource ID), where one SL-PRS resource identifier may uniquely identify one SL-PRS resource in the slot

$${t}_{{i}_{0}}^{e , j}$$

in the resource poor eⱼ. An example of allocation (or “mapping”) of SL-PRS resource identifiers is to traverse the

$${N}_{SR}^{e , j , t , {i}_{0}} SL - PRS$$

resources in a manner of first incrementing RE offsets in SL-PRS occasions and then incrementing SL-PRS occasion indexes in the slot and sequentially allocating SL-PRS resource identifiers 0, 1, . . . , and

$${N}_{SR}^{e , j , t , {i}_{0}} - 1.$$

Specifically, for example, if

$${N}_{SPO}^{e , j , t , {i}_{0}} = 3$$

and

$${N}_{SPR , m}^{e , j , t , {i}_{0}} = 2 ,$$

then SL-PRS resource identifiers corresponding to SL-PRS resources

$${spr}_{0 , 0}^{e , j , t , {i}_{0}} , {spr}_{0 , 1}^{e , j , t , {i}_{0}} , {spr}_{1 , 0}^{e , j , t , {i}_{0}} , {spr}_{1 , 1}^{e , j , t , {i}_{0}} , {spr}_{2 , 0}^{e , j , t , {i}_{0}} , and {spr}_{2 , 1}^{e , j , t , {i}_{0}}$$

are 0, 1, 2, 3, 4, and 5, respectively. Another example of allocation (or “mapping”) of SL-PRS resource identifiers is to traverse the

$${N}_{SR}^{e , j , t , {i}_{0}}$$

SL-PRS resources in a manner of first incrementing SL-PRS occasion indexes in the slot and then incrementing RE offsets in SL-PRS occasions and sequentially allocating SL-PRS resource identifiers 0, 1, . . . , and

$${N}_{SR}^{e , j , t , {i}_{0}} - 1$$

Specifically, for example, if

$${N}_{SPO}^{e , j , t , {i}_{0}} = 3 and {N}_{SPR , m}^{e , j , t , {i}_{0}} = 2 ,$$

then SL-PRS resource identifiers corresponding to SL-PRS resources

$${spr}_{0 , 0}^{e , j , t , {i}_{0}} , {spr}_{1 , 0}^{e , j , t , {i}_{0}} , {spr}_{2 , 0}^{e , j , t , {i}_{0}} , {spr}_{0 , 1}^{e , j , t , {i}_{0}} , {spr}_{1 , 1}^{e , j , t , {i}_{0}} , and {spr}_{2 , 1}^{e , j , t , {i}_{0}}$$

are 0, 1, 2, 3, 4, and 5, respectively.

For

$$m ∈ \{ 0 , 1 , … , {N}_{SPO}^{e , j , t , {i}_{0}} - 1 \} and q ∈ \{ 0 , 1 , … , {N}_{SPR , m}^{e , j , t , {i}_{0}} - 1 \} , SL - PRS$$

resource identifiers corresponding to SL-PRS resources

$${spr}_{m , q}^{e , j , t , {i}_{0}}$$

may be denoted as

$${spr}_{m , q}^{e , j , t , {i}_{0}} .$$

The slot

$${t}_{{i}_{0}}^{e , j}$$

may include one or more symbols used for automatic gain control (AGC). For example, for part or all of n satisfying

$$n ∈ \{ 0 , 1 , … , {N}_{L , m}^{e , j , t , {i}_{0}} - 1 \} ,$$

a preceding symbol

$$( e . g . , a symbol {l}_{m , n}^{e , j , t , {i}_{0}} - 1 )$$

of a symbol

$${l}_{m , n}^{e , j , t , {i}_{0}}$$

may be used for AGC.

The slot

$${t}_{{i}_{0}}^{e , j}$$

may include one or more symbols used for reception-to-transmission switching (RX-TX switching, or referred to as RX-TX turnaround, where RX may represent reception and TX may represent transmission). For example, for part or all of n satisfying

$$n ∈ \{ 0 , 1 , … , {N}_{L , m}^{e , j , t , {i}_{0}} - 1 \} ,$$

a following symbol

$$( e . g . , a symbol {l}_{m , n}^{e , j , t , {i}_{0}} + 1 )$$

of a symbol

$${l}_{m , n}^{e , j , t , {i}_{0}}$$

may be used for reception-to-transmission switching.

The slot

$${t}_{{i}_{0}}^{e , j}$$

may include one or more symbols for transmission-to-reception switching.

In the slot

$${t}_{{i}_{0}}^{e , j}$$

for

$$m ∈ \{ 0 , 1 , … , {N}_{SPO}^{e , j , t , {i}_{0}} - 1 \}$$

and

$$q ∈ \{ 0 , 1 , … , {N}_{SPR , m}^{e , j , t , {i}_{0}} - 1 \} ,$$

an SL-PRS resource

$${spr}_{m , q}^{e , j , t , {i}_{0}}$$

may be associated with a resource for PSCCH transmission (e.g., the resource is referred to as a “PSCCH resource” and is denoted as

$${pscr}_{m , q}^{e , j , t , {i}_{0}} ) ,$$

or it can be considered that

$${spr}_{m , q}^{e , j , t , {i}_{0}}$$

is associated with a PSCCH transmission (or SCI carried therein) on

$${pscr}_{m , q}^{e , j , t , {i}_{0}} .$$

In the slot

$${t}_{{i}_{0}}^{e , j} , {N}_{PSCR}^{e , j , t , {i}_{0}}$$

“PSCCH symbols” for PSCCH transmission may be predefined or preconfigured, where

$${N}_{PSCR}^{e , j , t , {i}_{0}}$$

may be an integer greater than or equal to 1.

$${N}_{PSCR}^{e , j , t , {i}_{0}}$$

may correspond to a predefined or preconfigured parameter, or may be determined according to one or more predefined or preconfigured parameter, or may be determined in other ways.

$${N}_{PSCR}^{e , j , t , {i}_{0}}$$

may be independent of i₀.
The

$${N}_{PSCR}^{e , j , t , {i}_{0}}$$

symbols may be consecutive symbols.
For each of the

$${N}_{PSCR}^{e , j , t , {i}_{0}}$$

symbols, one or more (e.g., all) of the following holds:
   the symbol is not used for SL-PRS.
   the symbol is not used for AGC.
   the symbol is not used for reception-to-transmission switching.
   the symbol is not used for transmission-to-reception switching.

In the slot

$${t}_{{i}_{0}}^{e , j} ,$$

for

$$m ∈ \{ 0 , 1 , … , {N}_{SPO}^{e , j , t , {i}_{0}} - 1 \}$$

and

$$q ∈ \{ 0 , 1 , … , {N}_{SPR , m}^{e , j , t , {i}_{0}} - 1 \} ,$$

each of one or more parameters of a PSCCH resource

$${pscr}_{m , q}^{e , j , t , {i}_{0}}$$

(or a corresponding PSCCH transmission) associated with an SL-PRS resource,

$${spr}_{m , q}^{e , j , t , {i}_{0}}$$

(or a corresponding SL-PRS transmission) (e.g., one or more frequency-domain parameters of

$${pscr}_{m , q}^{e , j , t , {i}_{0}} ,$$

such as an index of a lowest subchannel, or an index of a lowest RB of a lowest subchannel, or an index of a lowest subcarrier of a lowest RB of a lowest subchannel, or an index of a lowest RB, or an index of a lowest subcarrier of a lowest RB, or an index of a lowest subcarrier; for another example, each of one or more time-domain parameters of

$${pscr}_{m , q}^{e , j , t , {i}_{0}} ,$$

e.g., a starting symbol) may be determined according to one or more parameters of the SL-PRS resource

$${spr}_{m , q}^{e , j , t , {i}_{0}} .$$

For example, the “one or more parameters of the SL-PRS resource

$${spr}_{m , q}^{e , j , t , {i}_{0}} ”$$

may include one or more of the following:
m;
q;
an RE offset of the SL-PRS resource

$${spr}_{m , q}^{e , j , t , {i}_{0}}$$

(e.g., the RE offset may be equal to q).

$${spi}_{m , q}^{e , j , t , {i}_{0}} .$$

In the slot

$${t}_{{i}_{0}}^{e , j} ,$$

for a successfully received PSCCH transmission on a PSCCH resource (or for SCI carried in the PSCCH transmission), each of one or more parameters (e.g., including part or all of m_{z}, q_{z}, an RE offset, and an SL-PRS resource identifier) of an SL-PRS resource (e.g., denoted as

$${spr}_{{m}_{z} , {q}_{z}}^{e , j , t , {i}_{0}} )$$

associated may be determined according to one or more parameters of the PSCCH resource (or the PSCCH transmission). For example, the “one or more parameters of the PSCCH resource (or the PSCCH transmission)” may include one or more of:
an index of a lowest subchannel;
an index of a lowest RB of a lowest subchannel;
an index of a lowest subcarrier of a lowest RB of a lowest subchannel;
an index of a lowest RB;
an index of a lowest subcarrier of a lowest RB;
an index of a lowest subcarrier; and
a start symbol.

Optionally, part or all of SL-PRS resources in part or all of slots in the resource pool eⱼ are not associated with any PSCCH resource.

In a shared positioning resource pool (e.g., a resource pool e_{g} in a bandwidth part b in a carrier c), an SL-PRS transmission may be multiplexed in a slot with a PSCCH transmission and a PSSCH transmission associated with the PSCCH transmission, wherein the SL-PRS transmission may be referred to as an SL-PRS transmission associated with the PSCCH transmission (or SCI carried in the PSCCH transmission, or the PSSCH transmission, or the PSCCH/PSSCH transmission formed by multiplexing the PSCCH transmission and the PSSCH transmission, or SCI carried in the PSCCH/PSSCH transmission). The SCI carried in the PSCCH transmission (or the PSCCH/PSSCH transmission) may be used to indicate information related to the SL-PRS transmission. An offset between a lowest RB of an SL-PRS resource corresponding to the SL-PRS transmission and a lowest RB of a resource corresponding to the PSCCH transmission (or the PSSCH transmission, or the PSCCH/PSSCH transmission) associated with the SL-PRS transmission may correspond to a predefined or preconfigured parameter (e.g., 0). An offset between a highest RB of the SL-PRS resource corresponding to the SL-PRS transmission and a highest RB of the resource corresponding to the PSCCH transmission (or the PSSCH transmission, or the PSCCH/PSSCH transmission) associated with the SL-PRS transmission may correspond to a predefined or preconfigured parameter (e.g., 0). SL-PRS may correspond to one comb-like pattern and one corresponding RE offset (e.g., reusing an RE offset definition of an SL-PRS resource in a dedicated positioning resource pool, where

$${SC}_{m , q}^{e , j , t , {i}_{0}} ”$$

may be replaced with a set of all subcarriers corresponding to all RBs corresponding to the PSCCH/PSSCH transmission (or the PSSCH transmission).

An SL-PRS sequence r(m) corresponding to an SL-PRS transmission may be a sequence based on a pseudo-random sequence c(n), for example,

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

where,

$$c ( n ) = ( {x}_{1} ( n + {N}_{c} ) + {x}_{2} ( n + {N}_{c} ) ) mod 2$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

where N_{c}=1600·x₁(n) may be initialized as x₁(0)=0, x₁(1)=x₁(2)= . . . =x₁(30)=0. The initialization of x₂(n) may be completed using an initial value cᵢₙᵢₜ, where

$${c}_{init} = {Σ}_{i = 0}^{30} {x}_{2} ( i ) \cdot {2}^{i} .$$

cᵢₙᵢₜ may be related to one or more parameters associated with the SL-PRS transmission (or the SL-PRS resource where the SL-PRS transmission is located), for example, including one or more of:
   an SL-PRS sequence ID (e.g., denoted as

$${n}_{ID , seq}^{SLPRS}$$

an index (e.g., denoted as

$${n}_{s , f}^{μ}$$

of a slot where the SL-FAS transmission is located within a corresponding frame;
the number (e.g., denoted as

$${N}_{symb}^{slot}$$

of symbols in each slot; and
an index (l) of a symbol in a slot.

Specifically, for example, in the symbol l, cᵢₙᵢₜ may be expressed as

$${c}_{init} = ( {2}^{22} ⌊ \frac{{n}_{ID , seq}^{SLPRS}}{1024} ⌋ + {2}^{10} ( {N}_{symb}^{slot} {n}_{s , f}^{μ} + l + 1 ) ( 2 ( {n}_{ID , seq}^{SLPRS} mod 1024 ) + 1 ) + ( {n}_{ID , seq}^{SLPRS} mod 1024 ) ) mod {2}^{31}$$

Optionally,

$${n}_{ID , seq}^{SLPRS}$$

may be a parameter provided by a higher layer.

Optionally,

$${n}_{ID , seq}^{SLPRS}$$

may be determined in a predefined manner, for example,

$${n}_{ID , seq}^{SLPRS}$$

may correspond to part or all of bits of a CRC of a PSCCH transmission associated with a corresponding SL-PRS transmission.

### Embodiment 1

A method performed by a UE according to Embodiment 1 of the present invention will be described below with reference to FIG. 1.

FIG. 1 shows a flowchart corresponding to a method performed by a UE according to Embodiment 1 of the present invention.

As shown in FIG. 1, in Embodiment 1 of the present invention, steps performed by the UE include: step S101 and step S103.

Specifically, in step S101, SCI is received.

For example, the SCI received by the UE in a slot (e.g., the slot

$${t}_{{i}_{0}}^{e , j}$$

in a resource pool (e.g., the resource pool eⱼ) is denoted as

$${SCI}_{{k}_{0}}^{e , j , t , {i}_{0}} .$$

$${SCI}_{{k}_{0}}^{e , j , t , {i}_{0}}$$

may be “single-stage SCI”.

$${SCI}_{{k}_{0}}^{e , j , t , {i}_{0}}$$

may be part or all of “two-stage SCI”. For example,

$${SCI}_{{k}_{0}}^{e , j , t , {i}_{0}}$$

may be first-stage SCI; for another example,

$${SCI}_{{k}_{0}}^{e , j , t , {i}_{0}}$$

may be second-stage SCI; for another example,

$${SCI}_{{k}_{0}}^{e , j , t , {i}_{0}}$$

may include first-stage SCI and corresponding second-stage SCI.

Part or all of

$${SCI}_{{k}_{0}}^{e , j , t , {i}_{0}}$$

may be included in a sidelink PSCCH.

The PSCCH (or

$${SCI}_{{k}_{0}}^{e , j , t , {i}_{0}}$$

may be associated with (or schedule) an SL-PRS resource in the slot

$${t}_{{i}_{0}}^{e , j} ,$$

for example, an SL-PKS resource

$${spr}_{{m}_{0} , {q}_{0}}^{e , j , t , {i}_{0}}$$

(a corresponding SL-PRS resource identifier is

$${spi}_{{m}_{0} , {q}_{0}}^{e , j , t , {i}_{0}}$$

with index q₀ in an SL-PRS occasion m₀, where

$${m}_{0} ∈ \{ 0 , 1 , … , {N}_{SPO}^{e , j , t , {i}_{0}} - 1 \} , {q}_{0} ∈ \{ 0 , 1 , … , {N}_{SPR , {m}_{0}}^{e , j , t , {i}_{0}} - 1 \} .$$

One or more parameters of the SL-PRS resource

$${spr}_{{m}_{0} , {q}_{0}}^{e , j , t , {i}_{0}}$$

(e.g., m₀; or q₀; or

$$( e . g . , {m}_{0} ; or {q}_{0} ; or {spi}_{{m}_{0} , {q}_{0}}^{e , j , t , {i}_{0}} )$$

may be determined according to one or more parameters of the PSCCH (e.g., a frequency location of the PSCCH, e.g., a lowest RB or a lowest subchannel; or a start symbol of the PSCCH).

One or more parameters of the PSCCH (e.g., a frequency location of the PSCCH, e.g., the lowest RB or the lowest subchannel; or the start symbol of the PSCCH) may be determined according to one or more parameters of the SL-PRS resource

$${spr}_{{m}_{0} , {q}_{0}}^{e , j , t , {i}_{0}}$$

(e.g. m₀; or q₀; or

$${spi}_{{m}_{0} , {q}_{0}}^{e , j , t , {i}_{0}} ) .$$

It may be considered that the PSCCH (or

$${SCI}_{{k}_{0}}^{e , j , t , {i}_{0}} )$$

is associated with (or schedules) an SL-PRS transmission on the SL-PRS resource

$${spr}_{{m}_{0} , {q}_{0}}^{e , j , t , {i}_{0}} .$$

Furthermore, in step S103, one or more SL-PRS resources are determined.

For example, according to one or more of a first SL-PRS resource allocation indication, a second SL-PRS resource allocation indication, and a third SL-PRS resource allocation indication in

$${SCI}_{{k}_{0}}^{e , j , t , {i}_{0}} ,$$

part of all of information of

$${N}_{RSP}^{e , j , SCI , {k}_{0}} SL - PRS$$

resources (e.g., sequentially denoted as

$${r}_{0}^{e , j , SCI , {k}_{0}} , {r}_{1}^{e , j , SCI , {k}_{0}} , … , and {r}_{{N}_{RSP}^{e , j , SCI , {k}_{0}} - 1}^{e , j , SCI , {k}_{0}}$$

in chronological order) in the resource pool eⱼ is determined (e.g., time-domain information; or frequency-domain information; or a resource index; or a resource identifier), where

$${N}_{RSP}^{e , j , SCI , {k}_{0}}$$

may be an integer greater than or equal to

$${N}_{RSP}^{e , j , SCI , {k}_{0}}$$

may be an integer less than or equal to

$${N}_{RSP , max}^{e , j , SCI , {k}_{0}} ,$$

where

$${N}_{RSP , max}^{e , j , SCI , {k}_{0}} ,$$

may correspond to a predefined or preconfigured parameter, or may be determined according to one or more predefined or preconfigured parameters, or may be indicated in

$${SCI}_{{k}_{0}}^{e , j , t , {i}_{0}} ,$$

or may be determined in other ways. For example,

$${N}_{RSP , max}^{e , j , SCI , {k}_{0}} = 1 ; or ,$$

$${N}_{RSP , max}^{e , j , SCI , {k}_{0}} = 2 ; or ,$$

$${N}_{RSP , max}^{e , j , SCI , {k}_{0}} = 3 ; or ,$$

$${N}_{RSP , max}^{e , j , SCI , {k}_{0}} = 4 ; or ,$$

$${N}_{RSP , max}^{e , j , SCI , {k}_{0}} = 5 ; or ,$$

$${N}_{RSP , max}^{e , j , SCI , {k}_{0}} = 6.$$

$${N}_{RSP}^{e , j , SCI , {k}_{0}}$$

may correspond to a predefined or preconfigured parameter, or may be determined according to one or more predefined or preconfigured parameters, or may be indicated in

$${SCI}_{{k}_{0}}^{e , j , t , {i}_{0}} ,$$

or may be determined in other ways.

For another example, according to a first SL-PRS resource interval indication in

$${SCI}_{{k}_{0}}^{e , j , t , {i}_{0}} ,$$

one or more of the following is determined:
whether the

$${N}_{RSP}^{e , j , SCI , {k}_{0}} SL - PRS$$

resources are periodic SL-PRS resources;
a value of a period of the

$${N}_{RSP}^{e , j , SCI , {k}_{0}} SL - PRS$$

resources (e.g., referred to as a “resource reservation period” or a resource reservation interval) (e.g., denoted as

$$( e . g . , denoted as {RRI}_{RSP}^{e , j , SCI , {k}_{0}} ) .$$

The SL-PRS resources

$${r}_{0}^{e , j , SCI , {k}_{0}} , {r}_{1}^{e , j , SCI , {k}_{0}} , … , and {r}_{{N}_{RSP}^{e , j , SCI , {k}_{0}} - 1}^{e , j , SCI , {k}_{0}}$$

may be considered as resources assigned (or scheduled) by using

$${SCI}_{{k}_{0}}^{e , j , t , {i}_{0}} .$$

The resources

$${r}_{1}^{e , j , SCI , {k}_{0}} , … , and {r}_{{N}_{RSP}^{e , j , SCI , {k}_{0}} - 1}^{e , j , SCI , {k}_{0}}$$

may be considered as resources reserved by using

$${SCI}_{{k}_{0}}^{e , j , t , {i}_{0}} .$$

### For

$${N}_{RSP}^{e , j , SCI , {k}_{0}} = 1 ,$$

it may be considered that no resource is reserved by using

$${SCI}_{{k}_{0}}^{e , j , t , {i}_{0}} .$$

For

$$x ∈ \{ 0 , 1 , … , {N}_{RSP}^{e , j , SCI , {k}_{0}} - 1 \} ,$$

an SL-PRS resource

$${r}_{x}^{e , j , SCI , {k}_{0}}$$

may be

$${spr}_{{m}_{x}^{RA} , {q}_{x}^{RA}}^{e , j , t , {i}_{x}^{RA}}$$

in a slot

$${t}_{{i}_{x}^{RA}}^{e , j}$$

(a corresponding SL-PRS resource identifier is

$$( a corresponding SL - PRS resource identifier is {spr}_{{m}_{x}^{RA} , {q}_{x}^{RA}}^{e , j , t , {i}_{x}^{RA}} ) ,$$

where

$${m}_{x}^{RA}$$

may satisfy

$${m}_{x}^{RA} ∈ \{ 0 , 1 , … , {N}_{SPO}^{e , j , t , i {,}_{x}^{RA}} - 1 \} .$$

$${q}_{x}^{RA}$$

may satisfy

$${q}_{x}^{RA} ∈ \{ 0 , 1 , … , {N}_{SPR , {m}_{x}^{RA}}^{e , j , t , {i}_{x}^{RA}} - 1 \} .$$

$${i}_{x}^{RA}$$

may satisfy

$${i}_{x}^{RA} \geq {i}_{0} .$$

The slot

$${t}_{{i}_{0}^{RA}}^{e , j}$$

and the slot

$${t}_{{i}_{0}}^{e , j}$$

may be the same slot (i.e.,

$${i}_{0}^{RA} = {i}_{0} ,$$

accordingly,

$${t}_{{i}_{0}^{RA}}^{e , j} = {t}_{{i}_{0}}^{e , j} ) .$$

$${m}_{0}^{RA}$$

may be equal to m₀.

$${q}_{0}^{RA}$$

may be equal to q₀.

$${spi}_{{m}_{0}^{RA} , {q}_{0}^{RA}}^{e , j , t , {i}_{0}^{RA}}$$

may be equal to

$${spi}_{{m}_{0} , {q}_{0}}^{e , j , t , {i}_{0}} .$$

$${r}_{0}^{e , j , SCI , {k}_{0}} and {spr}_{{m}_{0} , {q}_{0}}^{e , j , t , {i}_{0}}$$

may correspond to the same SL-PRS resource (e.g., an SL-PRS resource identified by the same RE offset in the same SL-PRS occasion in the same slot in the same resource pool; or an SL-PRS resource identified by the same SL-PRS resource identifier in the same slot in the same resource pool).

The slots

$${t}_{{i}_{0}^{RA}}^{e , j} , {t}_{{i}_{1}^{RA}}^{e , j} , … , and {t}_{{i}_{{N}_{RSP}^{e , j , SCI , {k}_{0}} - 1}^{RA}}^{e , j}$$

may be the same slot (i.e.,

$${i}_{0}^{RA} = {i}_{1}^{RA} = … = {i}_{{N}_{RSP}^{e , j , SCI , {k}_{o}} - 1}^{RA} ) ;$$

accordingly,

$${t}_{{i}_{0}^{RA}}^{e , j} = {t}_{{i}_{1}^{RA}}^{e , j} = … = {t}_{{i}_{{N}_{RSP}^{e , j , SCI , {k}_{o}} - 1}^{RA}}^{e , j} ) .$$

The slots

$${t}_{{i}_{0}^{RA}}^{e , j} , {t}_{{i}_{1}^{RA}}^{e , j} , … , and {t}_{{i}_{{N}_{RSP}^{e , j , SCI , {k}_{o}} - 1}^{RA}}^{e , j}$$

may be different from each other (e.g.,

$${i}_{0}^{RA} < {i}_{0}^{RA} < … < {i}_{{N}_{RSP}^{e , j , SCI , {k}_{o}} - 1}^{RA} ) ;$$

accordingly,

$${t}_{{i}_{0}^{RA}}^{e , j} < {t}_{{i}_{1}^{RA}}^{e , j} < … < {t}_{{i}_{{N}_{RSP}^{e , j , SCI , {k}_{o}} - 1}^{RA}}^{e , j} ) .$$

A relationship among the slots

$${t}_{{i}_{0}^{RA}}^{e , j} < {t}_{{i}_{1}^{RA}}^{e , j} , … , and {t}_{{i}_{{N}_{RSP}^{e , j , SCI , {k}_{o}} - 1}^{RA}}^{e , j}$$

may be related to a resource interval granularity (e.g., denoted as

$${RIG}_{RSP}^{e , j , SCI , {k}_{0}} ) .$$

For example, if

$${RIG}_{RSP}^{e , j , SCI , {k}_{0}}$$

is “intra-slot allocation”, then the slots

$${t}_{{i}_{0}^{RA}}^{e , j} , {t}_{{i}_{1}^{RA}}^{e , j} , … , and {t}_{{i}_{{N}_{RSP}^{e , j , SCI , {k}_{o}} - 1}^{RA}}^{e , j}$$

are the same slot (i.e.,

$${i}_{0}^{RA} = {i}_{1}^{RA} = … = {i}_{{N}_{RSP}^{e , j , SCI , {k}_{o}} - 1}^{RA} ;$$

accordingly,

$${t}_{{i}_{0}^{RA}}^{e , j} = {t}_{{i}_{1}^{RA}}^{e , j} = … = {t}_{{i}_{{N}_{RSP}^{e , j , SCI , {k}_{o}} - 1}^{RA}}^{e , j} ) .$$

For another example, if

$${RIG}_{RSP}^{e , j , SCI , {k}_{0}}$$

is “inter-slot allocation”, then the slots

$${t}_{{i}_{0}^{RA}}^{e , j} , {t}_{{i}_{1}^{RA}}^{e , j} , … , and {t}_{{i}_{{N}_{RSP}^{e , j , SCI , {k}_{o}} - 1}^{RA}}^{e , j}$$

are slots different from each other (e.g.,

$${i}_{0}^{RA} < {i}_{1}^{RA} < … < {i}_{{N}_{RSP}^{e , j , SCI , {k}_{o}} - 1}^{RA} ;$$

accordingly,

$${t}_{{i}_{0}^{RA}}^{e , j} < {t}_{{i}_{1}^{RA}}^{e , j} < … < {t}_{{i}_{{N}_{RSP}^{e , j , SCI , {k}_{o}} - 1}^{RA}}^{e , j} ) .$$

$${RIG}_{RSP}^{e , j , SCI , {k}_{0}}$$

may correspond to one predefined or preconfigured parameter (e.g.,

$${RIG}_{RSP}^{e , j , SCI , {k}_{0}}$$

may be predefined or preconfigured as “intra-slot allocation”; or

$${RIG}_{RSP}^{e , j , SCI , {k}_{0}}$$

may be predefined or preconfigured as “inter-slot allocation”), or may be determined according to one or more predefined or preconfigured parameters, or may be indicated in

$${SCI}_{{k}_{0}}^{e , j , t , {i}_{0}}$$

(e.g.,

$${RIG}_{RSP}^{e , j , SCI , {k}_{0}}$$

may be indicated by

$${SCI}_{{k}_{0}}^{e , j , t , {i}_{0}}$$

as “intra-slot allocation”; or

$${RIG}_{RSP}^{e , j , SCI , {k}_{0}}$$

may be indicated by

$${SCI}_{{k}_{0}}^{e , j , t , {i}_{0}}$$

as “inter-slot allocation”), or may be determined in other ways.

$${m}_{0}^{RA} , {m}_{1}^{RA} , , … , and {m}_{{N}_{RSP}^{e , j , SCI , {k}_{0}} - 1}^{RA}$$

may be equal (i.e.,

$$( i . e . , {m}_{0}^{RA} = {m}_{1}^{RA} = … = {m}_{{N}_{RSP}^{e , j , SCI , {k}_{0}} - 1}^{RA} ) .$$

For example, for

$$x = 0 , 1 , … , {N}_{RSP}^{e , j , SCI , {k}_{0}} - 1 , {m}_{x}^{RA} = {m}_{0}$$

always holds.

$${q}_{0}^{RA} , {q}_{1}^{RA} , … , and {q}_{{N}_{RSP}^{e , j , SCI , {k}_{0}} - 1}^{RA}$$

may be equal (i.e.,

$$( i . e . , {q}_{0}^{RA} = {q}_{1}^{RA} = … = {q}_{{N}_{RSP}^{e , j , SCI , {k}_{0}} - 1}^{RA} ) .$$

For example, for

$$x = 0 , 1 , … , {N}_{RSP}^{e , j , SCI , {k}_{0}} - 1 , {q}_{x}^{RA} = {q}_{0}$$

always holds.

$${spi}_{{m}_{0}^{RA} , {q}_{0}^{RA}}^{e , j , t , {i}_{0}^{RA}} , {spi}_{{m}_{1}^{RA} , {q}_{1}^{RA}}^{e , j , t , {i}_{1}^{RA}} , … , and , {spi}_{{m}_{{N}_{RSP}^{e , j , SCI , {k}_{0}} - 1}^{RA}}^{e , j , t , {i}_{{N}_{RSP}^{e , j , SCI , {k}_{0}} - 1}^{RA}} , {q}_{{N}_{RSP}^{e , j , SCI , {k}_{0}} - 1}^{RA}$$

may be equal (i.e.,

$$( i . e . , {spi}_{{m}_{0}^{RA} , {q}_{0}^{RA}}^{e , j , t , {i}_{0}^{RA}} = {spi}_{{m}_{1}^{RA} , {q}_{1}^{RA}}^{e , j , t , {i}_{1}^{RA}} = … = {spi}_{{m}_{{N}_{RSP}^{e , j , SCI , {k}_{0}} - 1}^{RA} , {q}_{{N}_{RSP}^{e , j , SCI , {k}_{0}} - 1}^{RA}}^{e , j , t , {i}_{{N}_{RSP}^{e , j , SCI , {k}_{0}} - 1}^{RA}} ) .$$

For example, for

$$x = 0 , 1 , … , {N}_{RSP}^{e , j , SCI , {k}_{0}} - 1 , {spi}_{{m}_{x}^{RA} , {q}_{x}^{RA}}^{e , j , t , {i}_{x}^{RA}} = {spi}_{{m}_{0} , {q}_{0}}^{e , j , t , {i}_{0}}$$

always holds.

The first SL-PRS resource allocation indication, the second SL-PRS resource allocation indication, and the third SL-PRS resource allocation indication may correspond to a first resource indicator value (e.g., denoted as RIV₁), a second resource indicator value (e.g., denoted as RIV₂), and a third resource indicator value (e.g., denoted as RIV₃), respectively.

For y∈{0, 1, 2}, RIV_{y} may be determined according to one or more fields in

$${SCI}_{{k}_{0}}^{e , j , t , {i}_{0}}$$

related to resource indication (or allocation, or reservation).

For y₁∈{0, 1, 2}, and y₂∈{0, 1, 2}, and y₁≠y₂, one or more fields used to determine RIV_{y1} may be different from one or more fields used to determine RIV_{y2}.

For y∈{0, 1, 2}, RIV_{y} may be used to indicate and/or determine one or more of the following:

$${N}_{RSP}^{e , j , SCI , {k}_{0}} ;$$

part or all of

$${t}_{{i}_{0}^{RA}}^{e , j} , {t}_{{i}_{1}^{RA}}^{e , j} , … , and {t}_{{N}_{RSP}^{e , j , SCI , {k}_{0}} - 1}^{e , j} ( e . g . , {t}_{{i}_{1}^{RA}}^{e , j} , … , and {t}_{{i}_{{N}_{RSP}^{e , j , SCI , {k}_{0}} - 1}^{RA}}^{e , j} ) ;$$

part or all of

$${m}_{0}^{RA} , {m}_{1}^{RA} , … , and {m}_{{N}_{RSP}^{e , j , SCI , {k}_{0}} - 1}^{RA} ( e . g . , {m}_{1}^{RA} , … , and {m}_{{N}_{RSP}^{e , j , SCI , {k}_{0}} - 1}^{RA} ) ;$$

part or all of

$${q}_{0}^{RA} , {q}_{1}^{RA} , … , and {q}_{{N}_{RSP}^{e , j , SCI , {k}_{0}} - 1}^{RA} ( e . g . , {q}_{1}^{RA} , … , and {q}_{{N}_{RSP}^{e , j , SCI , {k}_{0}} - 1}^{RA} ) ;$$

part or all of

$${spi}_{{m}_{0}^{RA} , {q}_{0}^{RA}}^{e , j , t , {i}_{0}^{RA}} , {spi}_{{m}_{1}^{RA} , {q}_{1}^{RA}}^{e , j , t , {i}_{1}^{RA}} , … , and {spi}_{{m}_{{N}_{RSP}^{e , j , SCI , {k}_{0}} - 1}^{RA} , {q}_{{N}_{RSP}^{e , j , SCI , {k}_{0}} - 1}^{RA}}^{e , j , t , {i}_{{N}_{RSP}^{e , j , SCI , {k}_{0}} - 1}^{RA}}$$

$$( e . g . , {spi}_{{m}_{1}^{RA} , {q}_{1}^{RA}}^{e , j , t , {i}_{1}^{RA}} , … , and {spi}_{{m}_{{N}_{RSP}^{e , j , SCI , {k}_{0}} - 1}^{RA} , {q}_{{N}_{RSP}^{e , j , SCI , {k}_{0}} - 1}^{RA}}^{e , j , t , {i}_{{N}_{RSP}^{e , j , SCI , {k}_{0}} - 1}^{RA}} ) ;$$

For example, if

$${N}_{RSP}^{e , j , SCI , {k}_{0}} = 1 , then {RIV}_{y} = 0.$$

For another example, if

$${N}_{RSP}^{e , j , SCI , {k}_{0}} = 2 , then {RIV}_{y} = {t}_{1} ,$$

where t₁ may be determined in one of the following ways:

$${t}_{1} = Δ ( {t}_{{i}_{0}^{RA}}^{e , j} , {t}_{{i}_{1}^{RA}}^{e , j} ) .$$

$${t}_{1} = Δ ( {i}_{0}^{RA} , {i}_{1}^{RA} ) .$$

$${t}_{1} = Δ ( {m}_{0}^{RA} , {m}_{1}^{RA} ) .$$

$${t}_{1} = Δ ( {q}_{0}^{RA} , {q}_{1}^{RA} ) .$$

$${t}_{1} = Δ ( {spi}_{{m}_{0}^{RA} , {q}_{0}^{RA}}^{e , j , t , {i}_{0}^{RA}} , {spi}_{{m}_{1}^{RA} , {q}_{1}^{RA}}^{e , j , t , {i}_{1}^{RA}} ) .$$

For another example, if

$${N}_{RSP}^{e , j , SCI , {k}_{0}} = 3 and {t}_{2} - {t}_{1} - 1 \leq {W}_{1}^{y} ,$$

$$then {RIV}_{y} = {W}_{2}^{y} \cdot ( {t}_{2} - {t}_{1} - 1 ) + {t}_{1} + {W}_{3}^{y} .$$

t₂ may be determined in one of the following ways:

$${t}_{2} = Δ ( {t}_{{i}_{0}^{RA}}^{e , j} , {t}_{{i}_{2}^{RA}}^{e , j} ) .$$

$${t}_{2} = Δ ( {i}_{0}^{RA} , {i}_{2}^{RA} ) .$$

$${t}_{2} = Δ ( {m}_{0}^{RA} , {m}_{2}^{RA} ) .$$

$${t}_{2} = Δ ( {q}_{0}^{RA} , {q}_{2}^{RA} ) .$$

$${t}_{2} = Δ ( {spi}_{{m}_{0}^{RA} , {q}_{0}^{RA}}^{e , j , t , {i}_{0}^{RA}} , {spi}_{{m}_{2}^{RA} , {q}_{2}^{RA}}^{e , j , t , {i}_{2}^{RA}} ) .$$

For

$$z ∈ \{ 1 , 2 , 3 \} , {W}_{z}^{y}$$

may corresponding to a predefined or preconfigured parameter, or may be determined according to one or more predefined or preconfigured parameters, or may be determined in other ways.

For another example, if

$${N}_{RSP}^{e , j , SCI , {k}_{0}} = 3 and {t}_{2} - {t}_{1} - 1 \leq {W}_{1}^{y} ,$$

$$then {RIV}_{y} = {W}_{4}^{y} \cdot ( {W}_{5}^{y} - {t}_{2} + {t}_{1} ) + {W}_{6}^{y} - {t}_{1} .$$

$$For z ∈ \{ 4 , 5 , 6 ) , {W}_{z}^{y}$$

may corresponding to a predefined or preconfigured parameter, or may be determined according to one or more predefined or preconfigured parameters, or may be determined in other ways.

Part or all of

$${W}_{1}^{y} , {W}_{2}^{y} , {W}_{3}^{y} , {W}_{4}^{y} , {W}_{5}^{y} , and {W}_{6}^{y}$$

may be determined according to

$${W}_{RA}^{y} ,$$

where,

$${W}_{RA}^{y}$$

may be an integer greater than or equal to 1 (e.g.,

$${W}_{RA}^{y} = 31 ) .$$

$${W}_{RA}^{y}$$

may corresponding to a predefined or preconfigured parameter, or may be determined according to one or more predefined or preconfigured parameters, or may be determined in other ways.

Specifically, for example,

$${W}_{1}^{y} = ⌊ {W}_{RA}^{y} / 2 ⌋ .$$

For another example,

$${W}_{2}^{y} = {W}_{RA}^{y} - 1.$$

For another example,

$${W}_{3}^{y} = {W}_{RA}^{y} .$$

For another example,

$${W}_{4}^{y} = {W}_{RA}^{y} - 1.$$

For another example,

$${W}_{5}^{y} = {W}_{RA}^{y} .$$

For another example,

$${W}_{6}^{y} = 2 \cdot {W}_{RA}^{y} .$$

For y∈{0, 1, 2}, part or all of

$${W}_{1}^{y} , {W}_{2}^{y} , {W}_{3}^{y} , {W}_{4}^{y} , {W}_{5}^{y} , {W}_{6}^{y} and {W}_{RA}^{y}$$

may be independent of y.

For y₁∈{0, 1, 2}, and y₂∈{0, 1, 2}, and y₁≠y₂, content indicated by RIV_{y}_{₁} may be different from content indicated by RIV_{y}_{₂}.

The first SL-PRS resource interval indication may correspond to one or more fields in

$${SCI}_{{k}_{0}}^{e , j , t , {i}_{0}}$$

related to resource indication (or allocation, or reservation).

Optionally, if

$${RRI}_{RSP}^{e , j , SCI , {k}_{0}} = 0 ,$$

then the

$${N}_{RSP}^{e , j , SCI , {k}_{0}} SL - PRS$$

resources are not periodic SL-PRS resources.

Optionally, if

$${RRI}_{RSP}^{e , j , SCI , {k}_{0}} > 0 ,$$

then the

$${N}_{RSP}^{e , j , SCI , {k}_{0}} SL - PRS ,$$

resources are periodic SL-PRS resources, and a corresponding period is

$${RRI}_{RSP}^{e , j , SCI , {k}_{0}}$$

(e.g., in units of number of slots).

In this way, according to Embodiment 1, the present disclosure provides a method for using one or more parameters of an SL-PRS resource associated with SCI (e.g., an SL-PRS resource identifier; or an RE offset), to determine the same parameter of other SL-PRS resources indicated by the SCI, greatly improving the efficiency of signaling and simplifying the design of the SCI.

### Embodiment 2

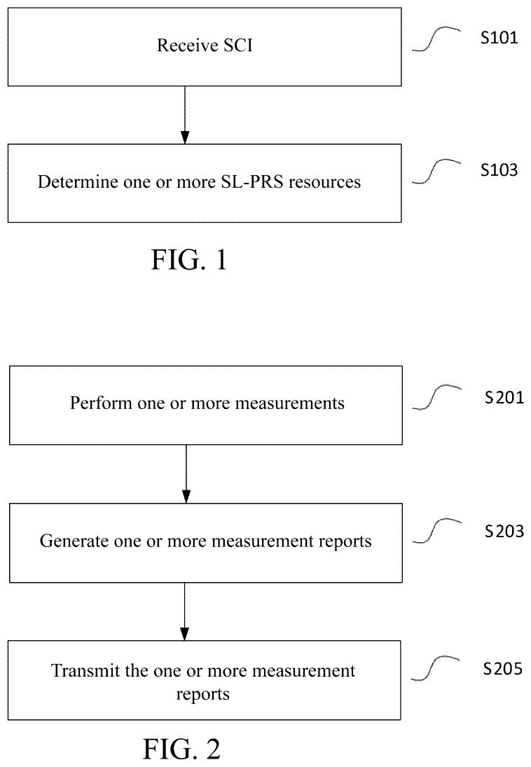

A method performed by a UE (e.g., referred to as a UE-A) according to Embodiment 2 of the present invention is described below with reference to FIG. 2, where the UE-A may be a target UE, or an anchor UE, or a server UE, or a UE in another form.

FIG. 2 illustrates a flowchart corresponding to the method performed by the UE-A according to Embodiment 2 of the present invention.

As illustrated in FIG. 2, in Embodiment 2 of the present invention, steps performed by the UE-A include: step S201, step S203, and step S205.

Specifically, in step S201, one or more measurements are performed.

For example, in the one or more measurements, a measurement (e.g., denoted as MN_{X}) may be a measurement of

$${N}_{RM}^{e , X} SL - PRS$$

resources (e.g., sequentially denoted as an SL-PRS resource

$${r}_{0}^{e , X , t , {i}_{0}^{RM}}$$

in a slot

$${t}_{{i}_{0}^{RM}}^{e , X} ,$$

an SL-PKS resource

$${r}_{1}^{e , X , t , {i}_{1}^{RM}}$$

in a slot

$${t}_{{i}_{1}^{RM}}^{e , X} , … ,$$

and an SL-PRS resource

$${r}_{{N}_{RM}^{e , X} - 1}^{e , j , t , {i}_{{N}_{RM}^{e , X} - 1}^{RM}}$$

in a slot

$${t}_{{i}_{{N}_{RM}^{e , x} - 1}^{RM}}^{e , X}$$

in chronological order) in a resource pool (e.g., denoted as resource in a slot e_{X}), where
e_{X} may be a shared positioning resource pool, e.g., e_{X}=e_{g}; accordingly, for

$$x ∈ \{ 0 , 1 , … , {N}_{RM}^{e , X} - 1 \} ,$$

an SL-PRS resource

$${r}_{x}^{e , X , t , {i}_{x}^{RM}}$$

may be multiplexed in a slot

$${t}_{{i}_{x}^{RM}}^{e , X}$$

with a PSCCH/PSSCH resource (or a PSSCH resource).
e_{X} may be a dedicated positioning resource pool, e.g., e_{X}=eⱼ; accordingly, for

$$x ∈ \{ 0 , 1 , … , {N}_{RM}^{e , X} - 1 \} ,$$

an SL-PRS resource

$${r}_{x}^{e , X , t , {i}_{x}^{RM}}$$

may correspond to

$${spr}_{{m}_{x}^{RM} , {q}_{x}^{RM}}^{e , j , t , {i}_{x}^{RM}}$$

in the slot

$${t}_{{{i}_{x}^{RM}}^{}}^{e , X} ,$$

where

$${m}_{x}^{RM} ∈ \{ 0 , 1 , … , {N}_{SPO}^{e , j , t , {i}_{x}^{RM}} - 1 \}$$

$$and$$

$${q}_{x}^{RM} ∈ \{ 0 , 1 , … , {N}_{SPR , {m}_{x}^{RM}}^{e , j , t , {i}_{x}^{RM}} - 1 \} .$$

$${N}_{RM}^{e , X}$$

may be an integer greater than or equal to 1.
For

$${x}_{1} ∈ \{ 0 , 1 , … , {N}_{RM}^{e , X} - 1 \}$$

$$and$$

$${x}_{2} ∈ \{ 0 , 1 , … , {N}_{RM}^{e , X} - 1 \} ,$$

$$and$$

$${x}_{1} \neq {x}_{2} , a slot {t}_{{i}_{{x}_{1}}^{RM}}^{e , X}$$

and a slot

$${t}_{{i}_{{x}_{2}}^{RM}}^{e , X}$$

may be the same slot (i.e.,

$$( i . e . , {i}_{{x}_{1}}^{RM} = {i}_{{x}_{2}}^{RM} ; accordingly$$

accordingly

$${t}_{{i}_{{x}_{1}}^{RM}}^{e , X} = {t}_{{i}_{{x}_{2}}^{RM}}^{e , X} ) ,$$

or not the same slot (i.e.,

$$( i . e . , {i}_{{x}_{1}}^{RM} \neq {i}_{{x}_{2}}^{RM} ;$$

accordingly

$${t}_{{i}_{{x}_{1}}^{RM}}^{e , X} = {t}_{{i}_{{x}_{2}}^{RM}}^{e , X} ) ,$$

In the one or more measurements, resource pools in which SL-PRS resources respectively corresponding to any two measurements are located may be different from each other.

In the one or more measurements, resource pools in which SL-PRS resources respectively corresponding to two or more measurements are located may be the same.

In the one or more measurements, a measurement (e.g., the measurement MN_{X}) may correspond to one of the following measurement types:
RSRP (Reference Signal Received Power) measurement based on SL-PRS;
RSRPP (Reference Signal Received Path Power) measurement based on SL-PRS;
RX-TX Time Difference measurement based on SL-PRS;
RSTD (Reference Signal Time Difference) measurement based on SL-PRS;
RTOA (Relative Time of Arrival) measurement based on SL-PRS;
AoA (Azimuth of Arrival) measurement based on SL-PRS; and
ZoA (Zenith of Arrival) measurement based on SL-PRS.

Further, in step 203, one or more measurement reports are generated.

For example, contents of the one or more measurement reports are determined respectively.

Specifically, for example, one or more of the following is performed:
Generate, according to the one or more measurements, a measurement report for reporting to an LMF (Location Management Function). For example, this may apply to a case where the UE-A is a target UE. For example, this may apply to a case where the UE-A is an anchor UE.
Generate, according to the one or more measurements, a measurement report for reporting to a target UE. For example, this may apply to a case where the UE-A is an anchor UE.
Generate, according to the one or more measurements, a measurement report for reporting to the server UE. For example, this may apply to a case where the UE-A is a target UE. For example, this may apply to a case where the UE-A is an anchor UE.

The one or more measurement reports may be respectively denoted as RP₀, RP₁, . . . RP_{N}_{_{RP}}₋₁, where N_{RP} may be an integer greater than or equal to 1.

For part or all of y₀ satisfying y₀∈{0, 1, . . . , N_{RP}−1}, part or all of contents of RP_{y}_{₀} related to the measurement MN_{X} may be determined according to one or more factors including the type (or use) of the resource pool e_{X}. For example, a field in RP_{y}_{₀} may be present when the resource pool e_{X} is a shared positioning resource pool (e.g., e_{X}=e_{g}), and absent when the resource pool e_{X} is a dedicated positioning resource pool (e.g., e_{X}=eⱼ). For another example, a field in RP_{y}_{₀} may be present when the resource pool e_{X} is a dedicated positioning resource pool (e.g., e_{X}=eⱼ), and may be absent when the resource pool e_{X} is a shared positioning resource pool (e.g., e_{X}=e_{g}). For another example, the size of a field in RR_{y}_{₀} when the resource pool e_{X} is a dedicated positioning resource pool (e.g., e_{X}=eⱼ) is different from the size of the field when the resource pool ex is a shared positioning resource pool (e.g., e_{X}=e_{g}). For another example, a method for determining the size of a field in RP_{y}_{₀} when the resource pool ex is a dedicated positioning resource pool (e.g., e_{X}=eⱼ) is different from a method for determining the size of the field when the resource pool ex is a shared positioning resource pool (e.g., e_{X}=e_{g}).

For part or all of y₀ satisfying y₀∈{0, 1, . . . , N_{RP}−1}, part or all of contents of RP_{y}_{₀} related to the measurement MN_{X} may be independent of the type (or use) of the resource pool e_{X}.

For part or all of y₀ satisfying y₀∈{0, 1, . . . , N_{RP}−1}, RP_{y}_{₀} may include measurement information. For example, in the measurement information, information related to the measurement MN_{X} may include one or more of the following:
identification information associated with the measurement MN_{X};
a measurement result corresponding to the measurement MN_{X};
one or more timestamps associated with the measurement MN_{X}; and
quality information associated with the measurement MN_{X}. For example, for an RTOA measurement, the quality information may include an assessment of uncertainty of a corresponding measurement result.

For the measurement MN_{X}, the identification information may include information for identifying the

$${N}_{RM}^{e , X} SL - PRS$$

resources, for example, identification information related to an SL-PRS resource

$${r}_{x}^{e , X , t , {i}_{x}^{RM}} ( x ∈ \{ 0 , 1 , … , {N}_{RM}^{e , X} - 1 \} )$$

may include one or more of the following:
The slot

$${i}_{x}^{RM}$$

(for example, represented by a corresponding slot index);
A subframe in which the slot

$${i}_{x}^{RM}$$

is located (e.g., represented by a corresponding subframe index);
A frame in which the slot

$${i}_{x}^{RM}$$

is located (e.g., represented by a corresponding frame index);
A type 1 resource pool type. For example, the type 1 resource pool type may be a resource pool type of the resource pool e_{X}, (e.g., for e_{X}=e_{g}, the resource pool type is “shared positioning resource pool”; or for e_{X}=eⱼ, the resource pool type is “dedicated positioning resource pool”);
A type 1 resource pool index. For example, the type 1 resource pool index may be an index of a resource pool (i.e., the resource pool e_{X}) in which the SL-PRS resource

$${r}_{x}^{e , X , t , {i}_{x}^{RM}}$$

is located;
A type 1 frequency index. For example, the type 1 frequency index may be an index of a lowest RB of the SL-PRS resource

$${r}_{x}^{e , X , t , {i}_{x}^{RM}} ,$$

or an index of a lowest subcarrier of the SL-PRS resource

$${r}_{x}^{e , X , t , {i}_{x}^{RM}}$$

(e.g., with subcarrier 0 of CRB 0 as a reference point of index “0”), or an index of a lowest subchannel of the SL-PRS resource

$${r}_{x}^{e , X , t , {i}_{x}^{RM}} ,$$

or an index of a lowest RB of the lowest subchannel of the SL-PRS resource

$${r}_{x}^{e , X , t , {i}_{x}^{RM}} ,$$

or an index of a lowest subcarrier of the lowest RB of the lowest subchannel of the SL-PRS resource

$${r}_{x}^{e , X , t , {i}_{x}^{RM}} .$$

Optionally, in a case where the resource pool e_{X} is a shared positioning resource pool (e.g., e_{X}=e_{g}), the type 1 frequency index is absent. Optionally, in a case where the resource pool e_{X} is a shared positioning resource pool (e.g., e_{X}=e_{g}), the type 1 frequency index corresponds to a predefined or preconfigured parameter (e.g., the value of the parameter is predefined as 0).
A type 2 frequency index, where the type 2 frequency index may be determined according to the type (or use) of the resource pool e_{X}. For example, in a case where the resource pool e_{X} is a shared positioning resource pool (e.g., e_{X}=e_{g}), the type 2 frequency index may be an index of a lowest RB of a PSCCH/PSSCH resource (or a PSSCH resource) multiplexed in the same slot with the SL-PRS resource

$${r}_{{x}_{0}}^{e , X , t , {i}_{0}^{RM}} ,$$

or an index of a lowest subcarrier of the PSCCH/PSSCH resource (or the PSSCH resource) (e.g., with subcarrier 0 of CRB 0 as a reference point of index “0”), or an index of a lowest subchannel of the PSCCH/PSSCH resource (or the PSSCH resource), or an index of a lowest RB of the lowest subchannel of the PSCCH/PSSCH resource (or the PSSCH resource), or an index of a lowest subcarrier of the lowest RB of the lowest subchannel of the PSCCH/PSSCH resource (or the PSSCH resource). For another example, in a case where the resource pool ex is a dedicated positioning resource pool (e.g., e_{X}=eⱼ), the type 2 frequency index is absent. For another example, in a case where the resource pool ex is a dedicated positioning resource pool (e.g., e_{X}=eⱼ), the type 2 frequency index corresponds to a predefined or preconfigured parameter (e.g., the value of the parameter is predefined as 0).
A type 1 frequency offset. For example, the type 1 frequency offset may be an RE offset of the SL-PRS resource

$${r}_{x}^{e , X , t , {i}_{x}^{RM}} .$$

Optionally, in the case where the resource pool e_{X} is a shared positioning resource pool (e.g., e_{X}=e_{g}), the type 1 frequency offset is absent. Optionally, in a case where the resource pool e_{X} is a shared positioning resource pool (e.g., e_{X}=e_{g}), the type 1 frequency offset corresponds to a predefined or preconfigured parameter (e.g., the value of the parameter is predefined as 0).
A type 1 resource occasion index. For example, in a case where the resource pool e_{X} is a dedicated positioning resource pool (e.g., e_{X}=eⱼ), the type 1 resource occasion index may be an index (e.g.,

$$( e . g . , {m}_{x}^{RM} )$$

of an “SL-PRS occasion” corresponding to the SL-PRS resource

$${r}_{x}^{e , X , t , {i}_{x}^{RM}} .$$

For another example, in a case where the resource pool e_{X} is a shared positioning resource pool (e.g., e_{X}=e_{g}), the type 1 resource occasion index is absent. For another example, in a case where the resource pool e_{X} is a shared positioning resource pool (e.g., e_{X}=e_{g}), the type 1 resource occasion index corresponds to a predefined or preconfigured parameter (e.g., the value of the parameter is predefined as 0).
A type 1 resource identifier. For example, in a case where the resource pool ex is a dedicated positioning resource pool (e.g., e_{X}=eⱼ), the type 1 resource identifier may be an SL-PRS resource identifier corresponding to the SL-PRS resource

$${r}_{x}^{e , X , t , {i}_{x}^{RM}}$$

$$( e . g . , {spi}_{{m}_{x}^{RM} , {q}_{x}^{RM}}^{e , j , t , {i}_{x}^{RM}} ) .$$

For another example, in a case where the resource pool e_{X} is a shared positioning resource pool (e.g., e_{X}=e_{g}), the type 1 resource identifier is absent. For another example, in a case where the resource pool ex is a shared positioning resource pool (e.g., e_{X}=e_{g}), the type 1 resource identifier corresponds to a predefined or preconfigured parameter (e.g., the value of the parameter is predefined as 0).
A type 1 serial identifier. For example, the type-1 serial identifier may be an SL-PRS serial identifier associated with the SL-PRS resource

$${r}_{x}^{e , X , t , {i}_{x}^{RM}}$$

(or a corresponding SL-PRS transmission).

Optionally, for the measurement MN_{X}, each of one or more of the following is always the same for the

$${N}_{RM}^{e , x} SL - PRS$$

resources, and, optionally, may be indicated only once in content related to the measurement MN_{X} in a measurement report (instead of indicated once for the

$${N}_{RM}^{e , x} SL PRS$$

resources separately):
the type 1 frequency index;
the type 2 frequency index;
the type 1 frequency offset;
the type 1 RE occasion index;
the type 1 resource identifier; and
the type 1 serial identifier.

In addition, in step S205, the one or more measurement reports are transmitted.

For example, each measurement report may be carried in a higher layer message for transmission, where the higher layer message may be an RRC message, an SLPP message, or a message in another form.

In this way, according to the description in Embodiment 2, the present disclosure provides a method, in which in a measurement report, part of content of the measurement report (e.g., one or more pieces of identification information of an SL-PRS resource) is determined according to the type (or use) of a resource pool in which the measured SL-PRS resource is located, reducing the redundancy of the content of the measurement report and improving the transmission efficiency of related signaling.

### Variant Embodiment

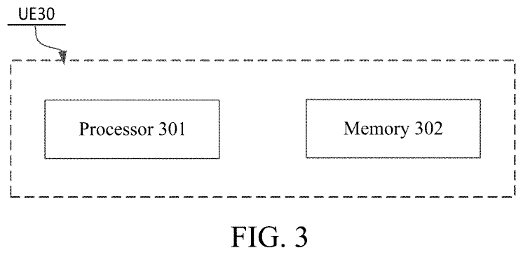

Hereinafter, FIG. 3 is used to illustrate a user equipment, as a variant embodiment, that can perform the method performed by a user equipment described in detail above in the present invention.

FIG. 3 is a block diagram showing the user equipment according to the present invention. As illustrated in FIG. 3, the user equipment (UE) 30 includes a processor 301 and a memory 302. The processor 301 may include, e.g., a microprocessor, a microcontroller, an embedded processor, etc. The memory 302 may, for example, include a volatile memory (e.g., a random access memory (RAM)), a hard disk drive (HDD), a non-volatile memory (e.g., a flash memory), or other memories. The memory 302 has program instructions stored thereon. The instructions, when run by the processor 301, can perform the method performed by user equipment described in detail in the present invention.

The method and related user equipment according to the present invention have been described above in combination with preferred embodiments. It should be understood by those skilled in the art that the method shown above is only exemplary, and the above-described embodiments can be combined with one another as long as no contradiction arises. The method of the present invention is not limited to the steps or sequences illustrated above. The user equipment illustrated above may include more modules. Various identifiers illustrated above are only exemplary, and are not meant to be limiting. The present invention is not limited to specific information elements serving as examples of these identifiers. Those skilled in the art could make various alterations and modifications according to the teachings of the illustrated embodiments.

It should be understood by those skilled in the art that any set is its own subset. An empty set is a subset of any set. Part or all of the mathematical expressions, mathematical equations, or mathematical inequalities may be simplified or transformed or rewritten to some extent (e.g., merging constant terms, or interchanging two addition terms, or interchanging two multiplication terms, or moving a term from the left side of an equation or inequality to the right side after changing the plus or minus sign thereof, or moving a term from the right side of an equation or inequality to the left side after changing the plus or minus sign thereof, or the like). Mathematical expressions, mathematical equations, or mathematical inequalities before and after the simplification or transformation or rewriting may be considered to be equivalent to each other.

It should be understood that the above-described embodiments of the present invention may be implemented by means of software, hardware, or a combination of software and hardware. For example, various components in the user equipment in the above embodiments may be implemented by means of multiple devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

In the present invention, the term “base station” may refer to mobile communication data and/or a control switching center having a certain transmission power and a certain coverage area, and, for example, having functions such as resource allocation and scheduling, and data reception and transmission. The term “user equipment” may refer to user mobile terminals, such as terminal devices that can wirelessly communicate with a base station or a micro base station, including a mobile phone, a laptop computer, and the like.

In addition, the embodiments of the present invention disclosed herein may be implemented on a computer program product. More specifically, the computer program product is a product provided with a computer-readable medium having computer program logic encoded thereon. When performed on a computing device, the computer program logic provides related operations to implement the above technical solutions of the present invention. When performed on at least one processor of a computing system, the computer program logic enables the processor to perform the operations (methods) described in the embodiments of the present invention. Such an arrangement of the present invention is typically provided as software, code, and/or other data structures that are configured or encoded on a computer-readable medium, such as an optical medium (e.g., a CD-ROM), a floppy disk or a hard disk, or, for example, firmware or other media of microcodes on one or more ROM or RAM or PROM chips, or downloadable software images, shared database and so on in one or more modules. Software or firmware or such configuration may be installed on a computing device such that one or more processors in the computing device performs the technical solutions described in the embodiments of the present invention.

In addition, each functional module or each feature of the user equipment used in each of the above embodiments may be implemented or performed by a circuit, and the circuit is usually one or more integrated circuits. Circuits designed to perform various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general-purpose processor may be a microprocessor, or the processor may be an existing processor, a controller, a microcontroller, or a state machine. The aforementioned general-purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-2. (canceled)

3: A User Equipment, comprising:
a processor; and
a memory in electronic communication with the processor, wherein instructions stored in the memory are executable to:
receive Sidelink Control Information (SCI) in a slot of a resource pool;
determine a number of N Sidelink Positioning Reference Signal (SL-PRS) resources based on indication in the SCI, wherein,
a SL-PRS resource identifier (ID) of a first SL-PRS resource of the N SL-PRS resources is determined according to a lowest subchannel of a Physical Sidelink Control Channel (PSCCH) conveying the SCI; and
the SL-PRS resource IDs of remaining N−1 SL-PRS resources reserved by the SCI are determined according to a Resource Indicator Value (RIV) indicated in the SCI.

4: A method performed by a User Equipment, comprising:
receiving Sidelink Control Information (SCI) in a slot of a resource pool;
determining a number of N Sidelink Positioning Reference Signal (SL-PRS) resources based on indication in the SCI, wherein,
a SL-PRS resource identifier (ID) of a first SL-PRS resource of the N SL-PRS resources is determined according to a lowest subchannel of a Physical Sidelink Control Channel (PSCCH) conveying the SCI; and
the SL-PRS resource IDs of remaining N−1 SL-PRS resources reserved by the SCI are determined according to a Resource Indicator Value (RIV) indicated in the SCI.
